(19) United States
(12) Patent Application Publication
(10) Pub. No.: US 2006/0190279 A1
(43) Pub. Date: Aug. 24, 2006

(54) System and method for marketing and managing real property

(76) Inventor: Brent Heflin, Long Beach, CA (US)

Correspondence Address: FULWIDER PATTON LEE & UTECHT, LLP, 200 OCEANGATE, SUITE 1550, LONG BEACH, CA, 90802, US

(21) Appl. No.: 11/065,641

(22) Filed: Feb. 24, 2005

(51) Int. Cl. G06Q 99/00

(52) U.S. Cl. 705/1

(57) ABSTRACT

A system and method for marketing and managing real property including a transaction server managed by a system administrator and a data manager that may be placed in communication with a remote terminal or client computer via a network communication line such as the Internet. The transaction server preferably provides an interface system in the form of a web site and maintains a network accessible database for a variety of end users to provide a central location for marketing residential and commercial properties based on collected property details for such properties as well as performing related transactions and property management functions.

### FIELD OF THE INVENTION

The present invention broadly relates to large scale network marketing and management services, and more particularly, to a system and method for handling the sale, rental, marketing and management of real property in a global network based environment.

### BACKGROUND OF THE INVENTION

Real estate marketing and management have commonly been conducted using paper intensive systems and generally lag behind other industries in embracing digital technology. For example, it is commonplace to place an advertisement for a property in a local newspaper providing a brief description of the property. This ad may or may not include a photograph of the property. The property owner pays the newspaper a fee for such advertisement. Then, an individual seeking to become a resident of the community by leasing or purchasing a residential or commercial property, must scan the same newspaper while the ad is in print. Once this prospective resident has selected a property based on the sparse information provided in the ad, the prospective resident typically contacts the owner or owner's representative by calling a phone number listed in the ad. For example, in a rental setting, the owner may take some preliminary information over the phone and may agree to show the property to the prospective renter. Once the property is shown, the owner provides the prospective renter with a rental agreement form. Often, the owner requires a credit check for which the prospective renter must pay a fee. If an agreement is entered into, the prospective renter will usually pay the first and last month's rent plus a security deposit.

In addition to being a paper intensive system, this typical transaction in the rental context exposes the owner, prospective renter, and surrounding neighbors of the rental property at risk. For instance, the owner is at risk as the background of the prospective renter is not thoroughly checked out other than a brief credit history check. The history check also will usually be conducted after the property is shown but before the rental agreement is drawn up. Thus, the criminal background of the prospective renter is unknown when the owner shows the property to the prospective renter, which leaves the owner susceptible to harm.

The prospective renter is similarly provided with insufficient information in the advertisement to make an informed decision, and will often waste significant time viewing several properties, many of which will not meet his or her criteria. The ads may also omit descriptions of the surrounding neighborhoods and local culture, leaving the prospective renter to discover this type of information from co-workers or neighbors, or through his or her own visit to the community. This is often a time consuming process. This problem is more acute for those renters relocating to an unfamiliar area. In addition, the newspaper ads are often outdated and the prospective renter wastes time calling on properties that are no longer available because the properties listings are only updated on a periodic basis.

Continuing in the rental context, the prospective renter is also exposed because the rental property may have hidden problems such as mold, water damage, and the like, which are certainly not discoverable from the ad and usually not discoverable from a brief walkthrough of the property. While the property owner may be liable if these hidden problems were known or should have been known, the time, cost, and effort to correct the situation will cause a significant burden on the prospective renter, and may be easily avoided if the property owner is forthright in providing the property details.

From the same perspective as the as the property owner, neighboring renters will be reassured in the safety of their neighborhood upon learning that the background of the prospective renter has been examined to determine if any problems exist, such as a history of criminal behavior or rental misconduct.

Another aspect generally lacking in such a rental transaction is a property management feature. Often, the property owner seeks merely to list the property and turn over its management to a property manager to collect the monthly rental fees and otherwise manage the property. The property owner will often contract with an independent property manager to run the property, thus adding another level of complexity to the transaction.

While current attempts exist to provide access through a network, such as the Internet, to property listings available for rental or purchase, these services often require the prospective resident to pay a subscription fee. In addition, the listings often only duplicate the sparse information found in the newsprint ads, and frequently contain out of date listings. Thus, the prospective resident often pays for outdated information, and is provided with little additional information other than that which can be learned by scanning the ads. Moreover, as the property owner stands to make the largest gains, in some instances it would be more appropriate for the property owner to bear the burden of advertising and search costs. In this regard, the property owner will be influenced by a desire to maintain a full tenancy or to sell the property with expedience.

While there are examples of recent publications that attempt to bring real estate into the 21^{st} century through automating some of the processes and conducting business via a web-based presence, these attempts have not adequately addressed the rental, sale, marketing, transactional and management processes for managing property keyed to the characteristics of a local community. One such example may be found in U.S. Patent Application Publication Ser. No. US2004/0030616 to Florance et al. In this publication, a unified commercial real estate data model is created through the collection, distribution, and use of information in connection with commercial real estate to create a web-based marketplace for buying and selling commercial properties. This system incorporates a database of property listings that may be searched based upon criteria input by a system user. Properties may be selected based on exemplary criteria such as type, geographic location, financial considerations and size. Results are provided in a listed format. Each listing may be expanded to provide details concerning the selected property. The expanded listings may include a photograph, floor plan, aerial view or additional textual details concerning the property. This system focuses on commercial real estate, and seeks to provide a “stock market like” exchange for commercial properties. Therefore, other features such as underwriting, confidentiality agreements, and mortgage loan procedures are also provided. Tenant information is also provided in the form of lease terms and expiration information to allow a prospective purchaser to gauge the likelihood of future tenancies and target tenants to lease space. This system does not provide a marketplace for renters, and attempts to focus on a large scale marketplace while sacrificing detail on a more local level.

Another attempt may be found in U.S. patent application publication Ser. No. US2002/0035535 to Brock, SR. The system described in this publication provides a means for providing real estate information over a network and comparing at least two properties using criteria entered by the user. The property criteria are given weighted values and each property is provided a total weighted score and a rating. The results of the comparison are then provided back to the user over the network. While this system does assist somewhat in the upfront selection of a property, further transaction between the property owner and prospective renter resident is not addressed. In addition, the user of the property comparator is charged a subscription fee, placing the search costs on him or her as opposed to the property owner or the owner's representative.

Yet another real estate transaction system is described in U.S. patent application publication Ser. No. US2004/0044696 to Frost. This system allows a participant to create, access, and modify the content of property files associated with parcels of land, and to integrate content into the property files from a variety of input sources. Property descriptions may include data pertaining to GPS information, maps, taxes, addresses, prices or other exemplary data that may be altered using a data management system. This system does not provide for rental agreement services.

An integrated property database and search engine is described in U.S. patent application publication No. US2004/0002871 to Geranio. The database generally includes information concerning the property, the buyer, the seller and the investors. A search engine allows a user to input selected criteria and displays a search results listing based on the criteria. Contact information is also provided so a buyer may contact a seller. This publication lacks a description as to the process which occurs after a property of interest is located, other than contacting the seller, and inadequately addresses the rental process.

Another approach of providing a real estate related system may be found in U.S. patent application publication Ser. No. US2003/0101074 to Suzuki et al. This system incorporates databases containing information related to real estate, resident profiles, natural environments, social environments, satellite imagery, and digitized map data. Data concerning these subjects may be transmitted over a network to a data information management module and made available to a search engine. Upon a user's request, search results may be displayed on a display device to the user. While this system does provide some information relating to the surrounding environment of a property, it is at most another information gathering tool and, for example, does not address the transactional process between the prospective renter and the property owner in the rental context.

A purported “one-stop-shop” web-based real estate transaction system is described and illustrated in U.S. patent application publication Ser. No. US2003/0187756 to Klivington et al. This system automates real estate processes and provides web-based accessibility to residential, commercial, and land markets. According to the publication, the system provides the ability to charge, collect, and track payments for real estate related transactions. This system is also described in terms of real estate purchases as opposed to providing a rental transaction process.

Another well known method for providing real estate listings is provided by the Multiple Listing Service (MLS) Regional information system. However, this is primarily used by real estate professionals who obtain information from the listings to service their customers. This system incorporates a real estate database that includes residential, multifamily, commercial, and land listings for the purpose of buying, selling, or leasing these properties. Again, the rental and sale transaction, marketing, and management processes are not addressed by this database alone.

What is needed and previously unavailable is a modernized, remotely accessible system for marketing and managing rental and sale properties in a given community or geographic region, which addresses the above described shortcomings while integrating a broad spectrum of local community information with information relating to the properties.

### SUMMARY OF THE INVENTION

In accordance with a preferred embodiment of the present invention, a method for selling, leasing, marketing and managing real property for a property owner is disclosed herein and generally includes receiving a set of property related information including a location parameter, a price parameter, and an amenities listing from the property owner and loading this information into a database accessible to a processing unit. This processing unit is further in communication with a display unit such that, upon a request from a prospective resident, the processing unit may transmit the property related information to a remote display device for consideration. In at least the rental context, the invention includes prescreening the prospective resident based on a set of personal information prior to showing the property. When an agreement is reached between the prospective resident and the property owner, a fee may be collected according to a fee arrangement with the owner.

Another feature of the present invention provides for a search page facilitating a search of the property related information by the prospective resident.

A series of related web pages for conducting a real estate transaction is also disclosed herein in which the web pages include local information about a specific geographic region in which available properties reside, and this information is integrated through selectable linking with the property related information for viewing by the prospective resident if desired.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is a block diagram illustrating a system for marketing and managing real property in accordance with a preferred embodiment of the present invention;

FIG. 2 is a schematic representation of a set of program modules and database fields for marketing and managing real property in accordance with a preferred embodiment of the present invention;

FIG. 3 is a schematic representation of an expanded realtor function illustrated in FIG. 2;

FIG. 4 is schematic representation of an expanded front end module illustrated in FIG. 2;

FIG. 5 is a schematic representation of an expanded realtor administration module illustrated in FIG. 2;

FIG. 6 is a schematic representation of an expanded backend administration module illustrated in FIG. 2;

FIG. 7 is a screen shot an exemplary home page of a web site in accordance with a preferred embodiment of the present invention;

FIG. 8 is a screen shot of the home page of FIG. 7 with an expanded Leasing & Rentals menu;

FIG. 9 is a screen shot of an exemplary rental page accessible through a rentals link on the expanded Leasing & Rentals menu of FIG. 8;

FIG. 10A is a screen shot of an exemplary simple search web page in accordance with the present invention;

FIG. 10B is a screen shot of the simple search web page in FIG. 10A with an exemplary pull down menu expanded;

FIG. 11 is a screen shot of an exemplary search results listing web page in accordance with a preferred embodiment of the present invention;

FIG. 12 is a screen shot of an exemplary property details listing web page in accordance with a preferred embodiment of the present invention;

FIG. 13 is a screen shot of an exemplary contact form in accordance with a preferred embodiment of the present invention;

FIG. 14 is a screen shot of an exemplary featured properties page in accordance with a preferred embodiment of the present invention;

FIGS. 15A-15B are screen shots of the upper and lower portions of an exemplary advanced search web page in accordance with a preferred embodiment of the present invention;

FIG. 16 is a screen shot of an exemplary local focus web page in accordance with a preferred embodiment of the present invention;

FIGS. 17-22 are screen shots of a set of sub-level web pages relating to the local focus web page of FIG. 16;

FIG. 23 is a modified screen shot of an exemplary administrative web page with navigation menu and broker listing in accordance with a preferred embodiment of the present invention;

FIG. 24 is a modified screen shot of an exemplary broker contact information web page with navigation menu in accordance with a preferred embodiment of the present invention;

FIG. 25 is a screen shot of an exemplary property queue web page with navigation menu in accordance with a preferred embodiment of the present invention;

FIG. 26 is a screen shot of an exemplary property listing web page with navigation menu in accordance with a preferred embodiment of the present invention;

FIGS. 27A-27E are screen shots of a single exemplary administrative edit property web page from top to bottom in accordance with a preferred embodiment of the present invention;

FIGS. 28A-28D are screen shots of a single administrative add new property web page from top to bottom in accordance with a preferred embodiment of the present invention;

FIG. 29 is a screen shot of an administrative neighborhood modification web page with navigation menu in accordance with a preferred embodiment of the present invention;

FIG. 30 is a screen shot of an administrative property type modification web page with navigation menu in accordance with a preferred embodiment of the present invention;

FIG. 31 is a screen shot of an administrative amenities modification web page with navigation menu in accordance with a preferred embodiment of the present invention;

FIG. 32 is a screen shot of an administrative lot features modification web page with navigation menu in accordance with a preferred embodiment of the present invention;

FIG. 33 is a screen shot of an administrative community features modification web page with navigation menu in accordance with a preferred embodiment of the present invention;

FIG. 34 is a screen shot of an administrative financial options modification web page with navigation menu in accordance with a preferred embodiment of the present invention;

FIG. 35 is a screen shot of an administrative category options modification web page with navigation menu in accordance with a preferred embodiment of the present invention;

FIG. 36 is a screen shot of an administrative parking options modification web page with navigation menu in accordance with a preferred embodiment of the present invention;

FIG. 37 is a screen shot of an administrative status modification web page with navigation menu in accordance with a preferred embodiment of the present invention;

FIGS. 38A and 38B are related flow diagrams of an exemplary process for marketing and managing a rental property in accordance with a preferred embodiment of the present invention;

FIG. 39 is a screen shot of an exemplary broker login screen in accordance with a preferred embodiment of the present invention; and

FIG. 40 is a screen shot of an exemplary realtor sign up form in accordance with a preferred embodiment of the present invention.

### DETAILED DESCRIPTION OF THE INVENTION

System Architecture

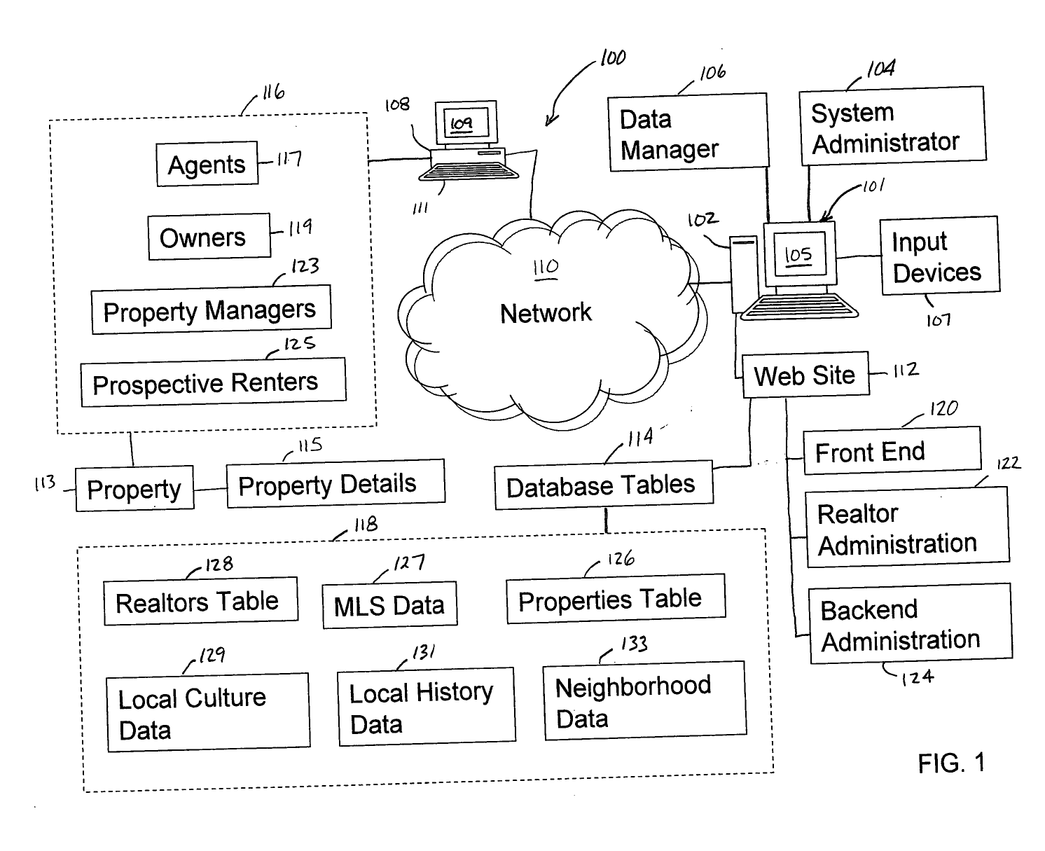

Referring now to FIG. 1, a real estate marketing and management system, generally designated 100, preferably includes a transaction server 102, managed by a system administrator 104 and a data manager 106, that may be placed in communication with a remote terminal or client computer 108 via a network communication line 110 such as the Internet. The transaction server provides an interface system in the form of a web site 112 constructed using conventional HTML or other suitable web based languages. The transaction server maintains a network accessible database 114 for a variety of end users, collectively designated 116, to provide a central location for marketing properties 113 using collected property details 115 for such properties as well as performing related transactions such as property management tasks.

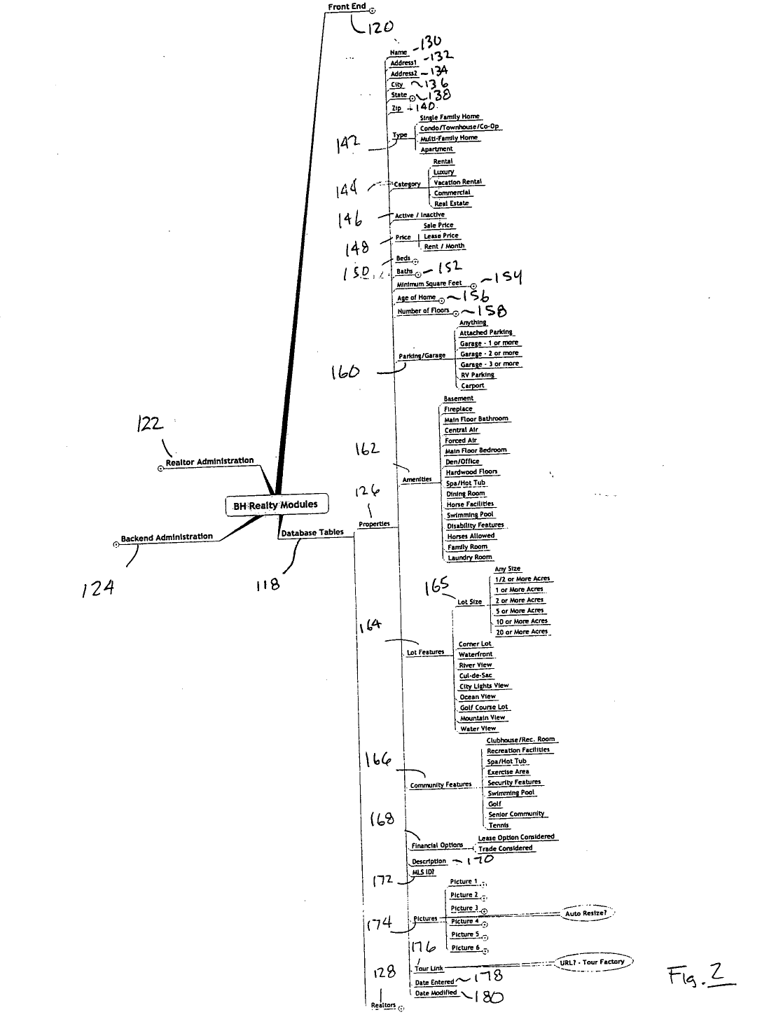

The transaction server includes a conventional processor and is loaded with a computer program or application for controlling and displaying the web site 112. The program generally includes four different program modules to address different aspects provided by the web site. Referring now to FIGS. 1-2, these modules include a database table module 118, a front end module 120, a realtor administration module 122, and a backend administration module 124. These modules cooperate and may be called upon by the computer program to generate the interactive web page displays and receive and process information input on the web pages.

The network 110 may be a LAN, WAN, the Internet or other suitable network for connecting multiple computers, terminals, and/or servers. It is preferable to use the Internet as a communication means between the end user computer 108 and the transaction server 102. The transaction server is a part of a transaction system, generally designated 101, and includes a display device 105, such as a monitor, and may be connected to any number of suitable input devices 107. Typical input devices include a keyboard, mouse, keypad, scanner, digital camera, or other suitable input device. Similarly, the end user terminal 108 may simply include a dumb terminal with a display device 109 connected to the network 110 or may be a conventional home computer or laptop or mobile telecommunication device having communication software and a display software, such as a conventional web browser, for displaying information transmitted from the transaction server over the network on the end user display device 109. The end user computer may also include an input device 1 1 such as any of those named above for the transaction server. Wireless communication between the network, the end user computer, and transaction server is also contemplated.

End users 116 are typically individuals interested in either obtaining information about a property and the related realty services or those interested in providing information to build the realty database 114. Typical end users will be representatives, agents or brokers for selling or leasing of properties (collectively “brokers” 117), property owners 119 interesting in leasing or selling a property, property managers 121, and prospective residents 123, such as prospective renters or purchasers, including those relocating from a significant distance and unfamiliar with the geographic region supported by the database 114.

Database Module

With continued reference to FIGS. 1 and 2, the database tables 118 comprise a number of database tables storing searchable information relating to the real estate marketing and management of a number of properties including the administrative functions associated with maintaining the web site 112. The database is preferably geographically specific and tailored to a particular local community or geographic region. In the exemplary embodiment described herein, that community and geographic region is Long Beach, California. The primary database tables are the properties table 126 and the realtors table 128. Other database tables, for example, may include an MLS data table 127 for storing information from MLS listings, a local culture data table 129 for storing information relating to the local culture of the geographic region supported by the database 114, a local history data table 131 for storing information relating to the history of the geographic region supported by the database, and a neighborhood database 133 for storing information relating to the various neighborhoods falling within the geographic region supported by the database.

The properties table 126 includes a number of different fields for storing property details 115 data concerning a particular property 113 or properties. The fields in this data table may include a name field 130, an address1 field 132, an address2 field 134, a city field 136, a state field 138, a zip field 140, a type field 142, a category field 144, an active/inactive field 146, a price field 148, a bed field 150, a baths field 152, a minimum square feet field 154, an age of home field 156, a number of floors field 158, a parking/garage field 160, an amenities field 162, a lot features field 164, a community features field 166, a financial options field 168, a description field 170, an MLS ID field 172, a pictures field 174, a tour link field 176, a date entered field 178, and a date modified field 180.

Within these fields, sub-fields may be included. For example, the state field 138 includes selectable sub-fields corresponding to each of the fifty U.S. States. The type field 142 includes sub-fields such a single family home, condominium/townhouse/coop, multi-family home, and apartment. The category field 144 comprises sub-fields such as rental, luxury, vacation rental, commercial, and real estate. The price field 148 includes sale price, lease price, and rent/month sub-fields. The beds field 150 is expandable to list the number of beds a typical property range will have such a 1, 2, 3, 4, or 5. The baths field 152 may include listing of sub-fields such as 1, 1.5, 2, 2.5, 3, or more. The minimum square feet field 154 comprises a number of different sub-fields for various square footage descriptors commonly associated with property such as 750 sq. ft., 1000 sq. ft., and so on in 250 sq. ft. increments or other incremental number as desired. The age of home field 156 is expandable from a range of less than 1 to 100 or more depending on the properties in the local area loaded into the database. The number of floors field 158 generally ranges from 1 to 3. The parking/garage field 160 addresses the parking situation of the properties and includes such descriptors as anything, attached parking, garage-1 or more, garage-2 or more, garage-3 or more, RV parking, and carport.

The amenities field 162 includes such selectable descriptors as basement, fireplace, main floor bathroom, central air, forced air, main floor bedroom, den/office, hardwood floors, spa/hot tub, dining room, horse facilities, swimming pool, disability features, horses allowed, family room, and laundry room.

The lot features field 164 includes a lot size sub-field 165 that includes descriptors any size, 2 or more acres, 1 or more acres, 2 or more acres, 5 or more acres, 10 or more acres, and 20 or more acres. The lot features field also includes sub-fields such as corner lot, waterfront, river view, cul-de-sac, city lights view, ocean view, golf course lot, mountain view, and water view.

The community features field 166 includes sub-fields clubhouse/rec. room, recreation facilities, spa/hot tub, exercise area, security features, swimming pool, golf, senior community, and tennis. Under the financial options field 168, lease option considered and trade considered sub-fields are stored. A description field 170 may store a brief description of the property input by the data manager or property owner during the data input process and typically adds information not covered by the other fields. The MLS ID field 172 is used for storing an MLS ID associated with the property.

The pictures field 174 stores a path or link to a location within the database 114 or transaction server 102 where photographs of the property are stored so that may be called up during the property display routine. The tour link field 176 provides a link to a 360 degree tour or other multimedia presentation of the property. The date entered field 178 stores an input associated with the first time property data is entered into a database property record. The date modified field 180 stores the latest date in which property data was modified in month, day, year or other suitable format.

Each of these fields and sub-fields may hold a property detail or details 115 that are generally descriptors of the property 113. The fields and sub-fields may also be added, deleted, or modified as will be described below in conjunction with web site administration. After the property details 115 data for at least one property is entered into the property table 126 as described below, the property table is searchable and may be accessed by a user to display property detail data satisfying a search criteria.

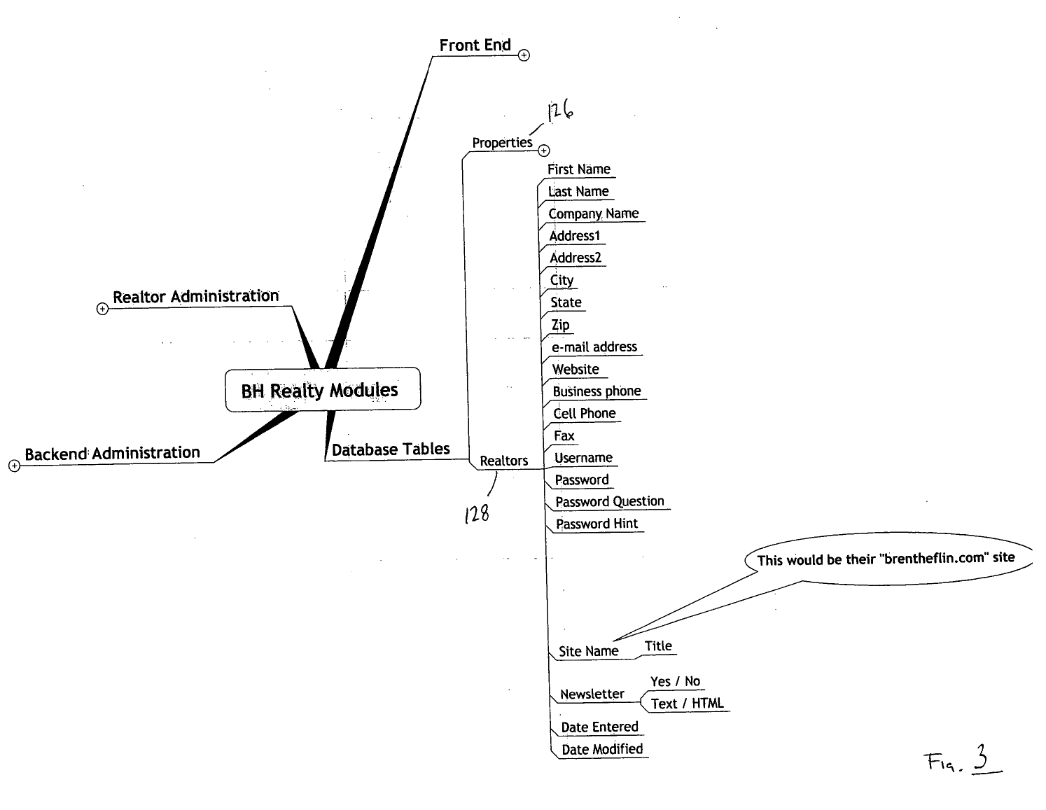

With reference now to FIGS. 1 and 3, the realtors table 128 also includes a number of sub-fields for storing information associated with a particular realtor including first name, last name, company name, address1, address2, city, state, zip, e-mail address, website, business phone, cell phone, fax, usemame, password, password question, password hint, site name and title, newsletter receipt (Yes/No), date entered, and date modified.

Front End Module

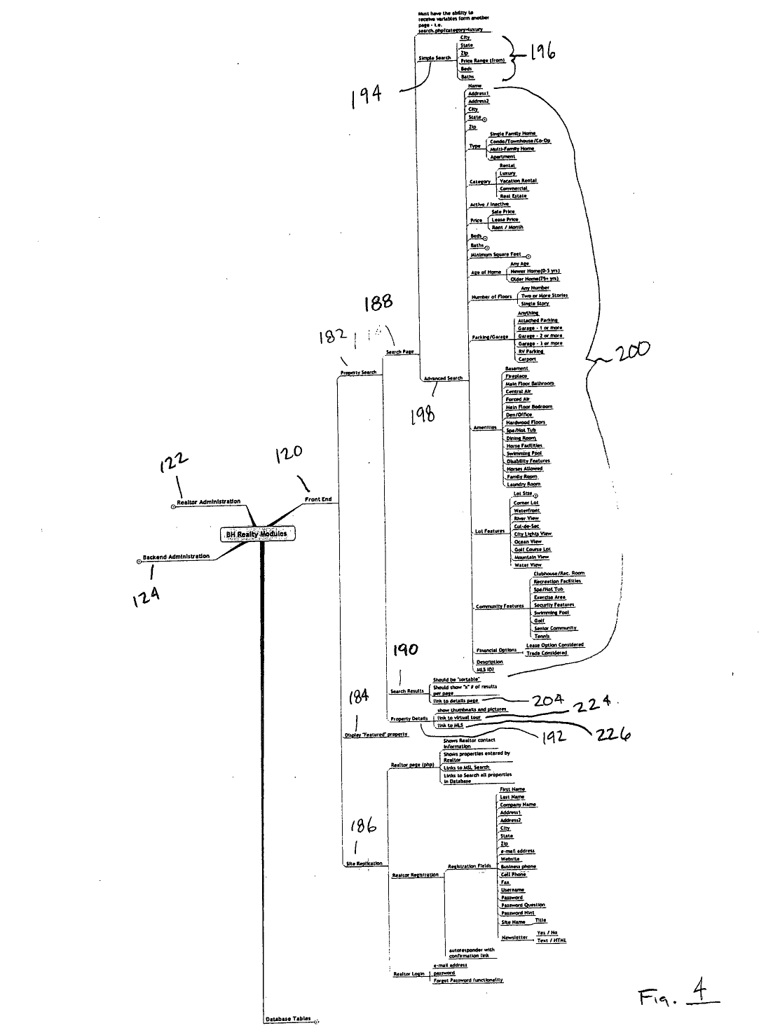

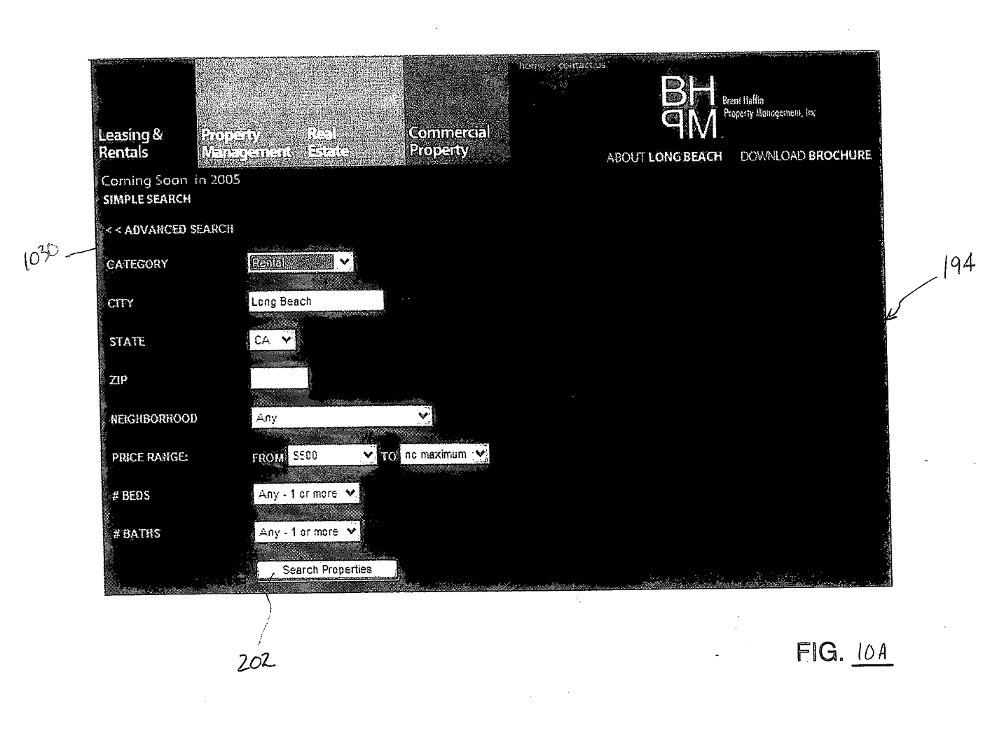

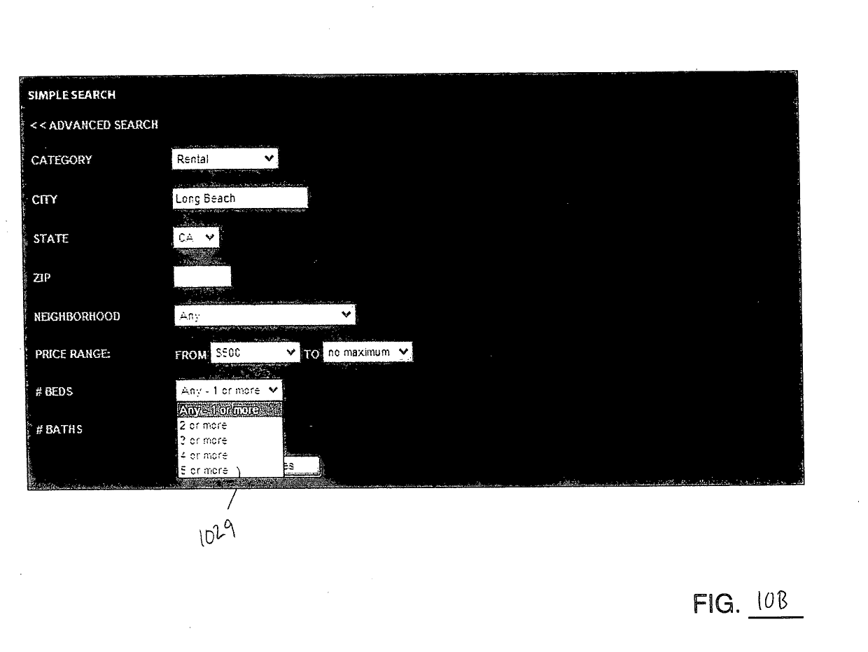

With reference to FIGS. 1 and 4, the Front End module 120 includes a property search function 182, a display featured property function 184, and a site replication function 186. The property search function includes a number of sub-functions including an interactive search page display function 188, a search results listing function 190 based on search criteria input by an end user 116, and a property details page display function 192 once a specific property from the search results listing is selected. There are two types of search pages 188. The first type is a simple search page 194. An exemplary simple search page is illustrated in FIG. 10A. This search page includes selection boxes or text input boxes for search parameters such as city, state, zip, price range, number of beds, and number of baths. The simple search parameters are collectively designated 196.

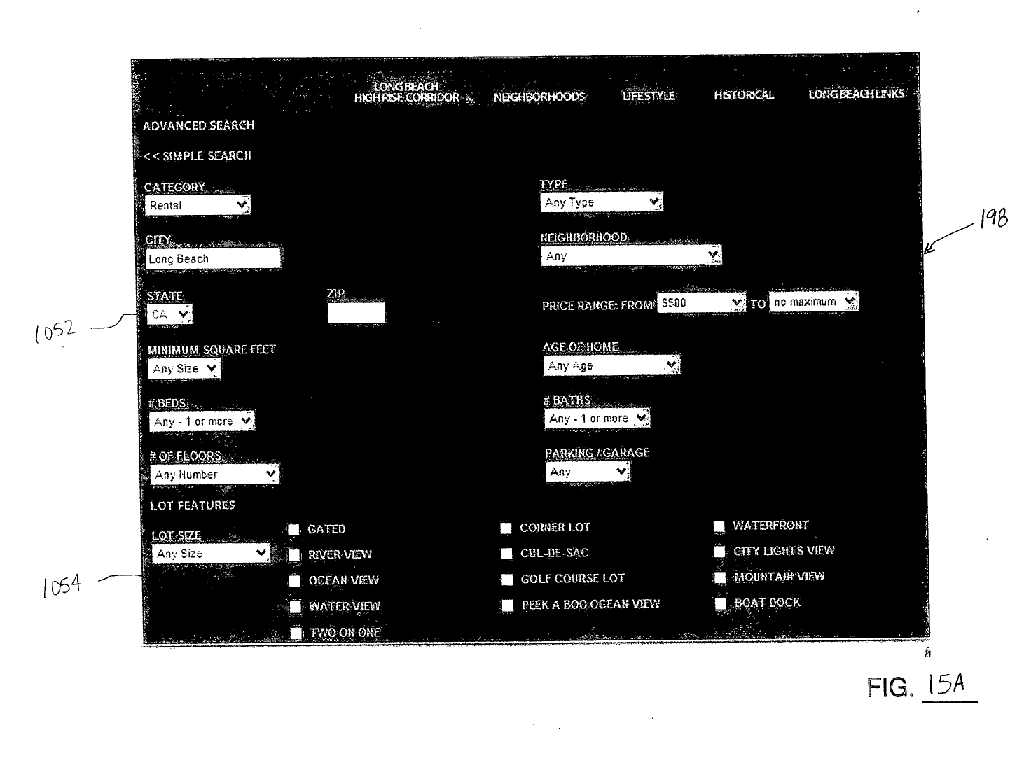

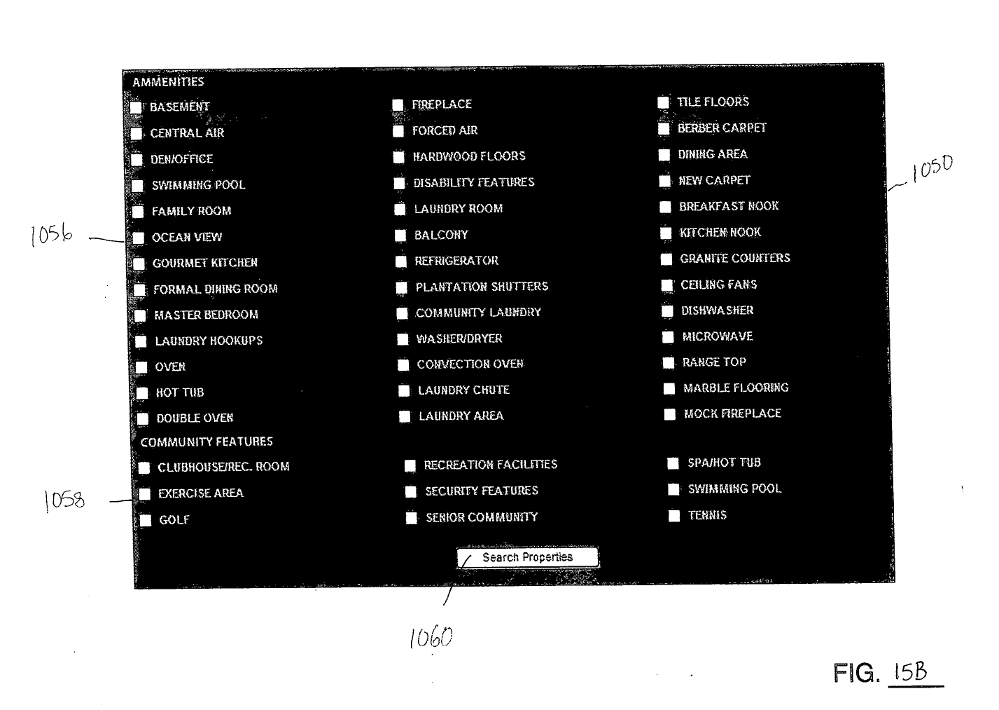

The other type of search page is the advanced search page 198. An exemplary advanced search page is illustrated in FIGS. 15A and 15B. This advanced search page allows an end user 116 to direct a search to a more specific set of property details and is a powerful tool in narrowing choices to a more specific set of properties 113. The advanced search page includes selection boxes or text input boxes for search parameters such as a name, address1, address2, city, state, zip, type (single family home, condominium, co-op, multi-family home, apartment), category (rental, luxury, vacation rental, commercial, real estate), active/inactive, price (sale price, lease price, rent/month), number of beds, number of baths, minimum square feet, age of home (any age, newer home 0-5 years, older home 75+ years), number of floors (any number, two or more stories, single story), parking/garage (anything, attached parking, garage 1 or more, garage 2 or more, garage 3 or more, RV parking, carport), amenities (basement, fireplace, main floor bathroom, central air, forced air, main floor bedroom, den/office, hardwood floors, spa/hot tub, dining room, horse facilities, swimming pool, disability features, horses allowed, family room, laundry room), lot features (lot size, corner lot, waterfront, river view, cul-de-sac, city lights view, ocean view, golf course lot, mountain view, water view), community features (clubhouse/rec. room, recreation facilities, spa/hot tub, exercise area, security features, swimming pool, golf, senior community, tennis), financial options (lease option considered, trade considered), description, and MLS ID. Collectively these advanced search parameters are designated 200. It will be appreciated that these advanced search parameters match or substantially match the data stored in the database tables 114 to enable an end user 116 to search a significant portion or the entire set of data stored in the database tables.

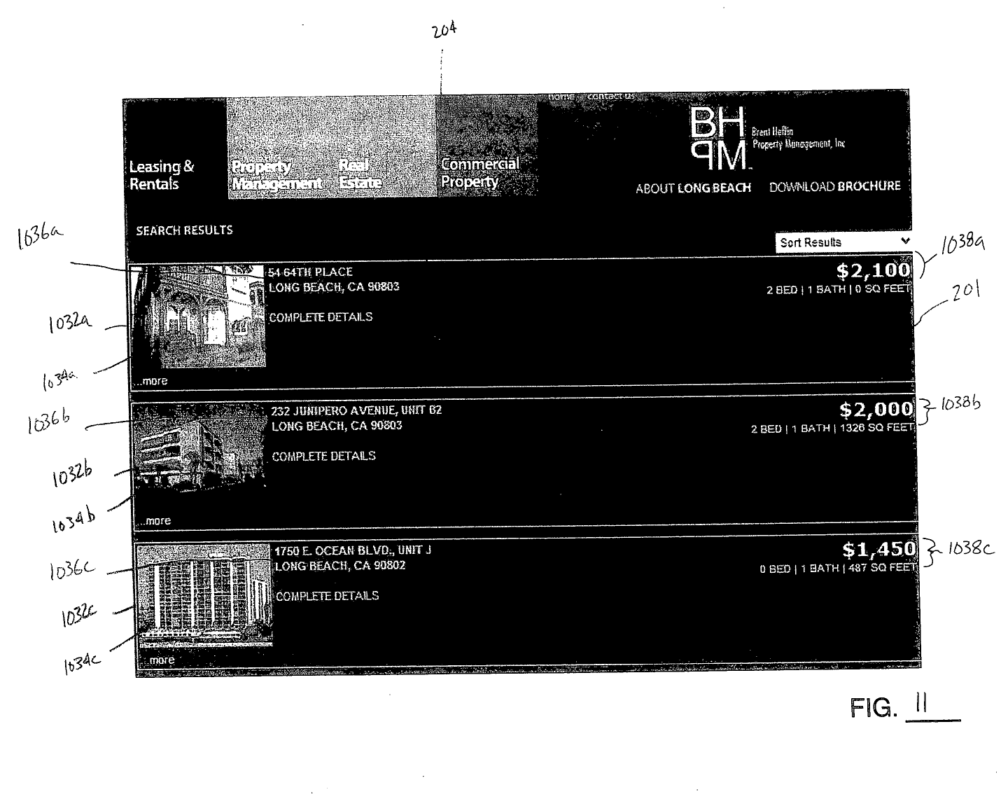

As explained in more detail below, a simple search results page 201 or results listing, such as that exemplified in FIG. 11, is displayed once an end user 116 inputs at least one search criteria into the interactive simple search form on the simple search page 194 and selects the search properties button 202 (FIG. 10A). The search results function 190 within the property search function 182 processes the search criteria input into the simple search table. The realty computer program then accesses the database tables 114, in particular, the property table 126, and pulls up for display a listing of those properties 113 in the database having property details 115 matching the search criteria. The search results listing may include at least one property matching the search criteria. If no properties match the search criteria, a notice indicating no results were found is displayed.

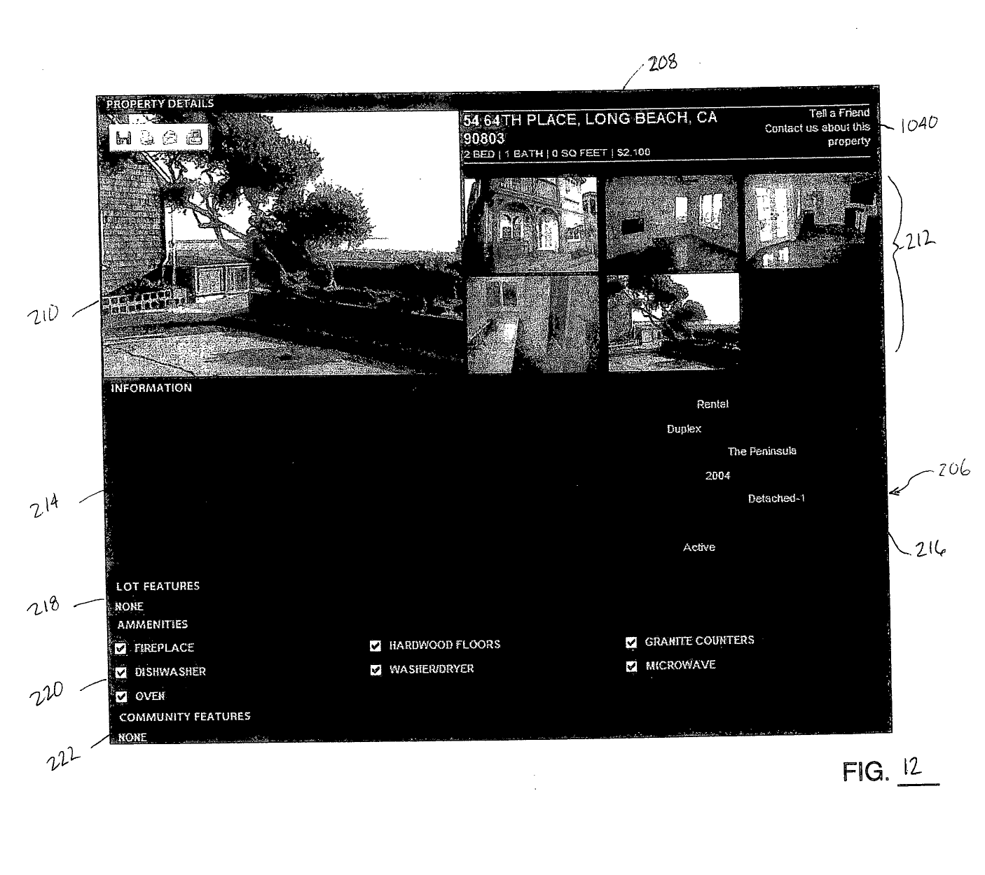

The search results listing 201 displays a number of search results per screen. This number may be selectable by the end user. The search results listing may include such information as a photograph of the property, property address, price, and basic information such as the number of beds, number of baths, and square footage. In addition, the search results listing includes a details link 204 to a property details page 206 (FIG. 12) for each property listed. For the user's convenience, the search results may be sorted by the end user 116 using such exemplary sorting criteria as price or square footage.

With reference to FIGS. 1, 4 and 12, selection of the property details link 204 causes the property details function 192 to access the database tables 114 to obtain further additional details describing the property. An exemplary property details page 206 is illustrated in FIG. 12. The property details page lists the same detail data as on the search results listing page 201 at 208. In addition to that detail data, there is a primary photograph section 210 and a thumbnail photograph section 212. In this example, there is one primary photograph in the primary photograph section and five thumbnail images in the thumbnail section. Selecting the image in the primary photograph section results in the display of an enlarged image of the primary photograph. Selecting a thumbnail photograph by moving a cursor over the thumbnail image and depressing a mouse button (not shown) of an input device 111 switches the photograph in the primary photograph section with the selected thumbnail image.

With continued reference to FIG. 12, set beneath the respective photograph sections 210 and 212, is a basic description section 214. This section may include a written description concerning the property as entered into the description field in property table 126 of the database 114. In addition, to the right of the written description is an “at a glance” section 216 that describes the details such as category, type, neighborhood location, year built, parking/garage, lot size, and status, if these details are known and stored in the database 114. Beneath these two sections is the lot features section 218 where any lot features stored in the database corresponding to the selected property 113 will be displayed.

Scrolling downwardly from the lot features section, the end user 116 will encounter the amenities section 220. This section lists all known amenities as determined by the database that the selected property includes. At the bottom of the property details page 206 is the community features section 222. This section will display any community features stored in the database. The property details page may also include a virtual tour link 224 and a MLS link 226. The virtual tour link may access a web site or multi-media program routine that includes may include a tour in the form of a walkthrough video of the property or allows the end user to select a photograph and rotate the view 360 degrees. The MLS link may enable the end user to view the information on the MLS page over the network or as stored in the MLS data table 127 (FIG. 1).

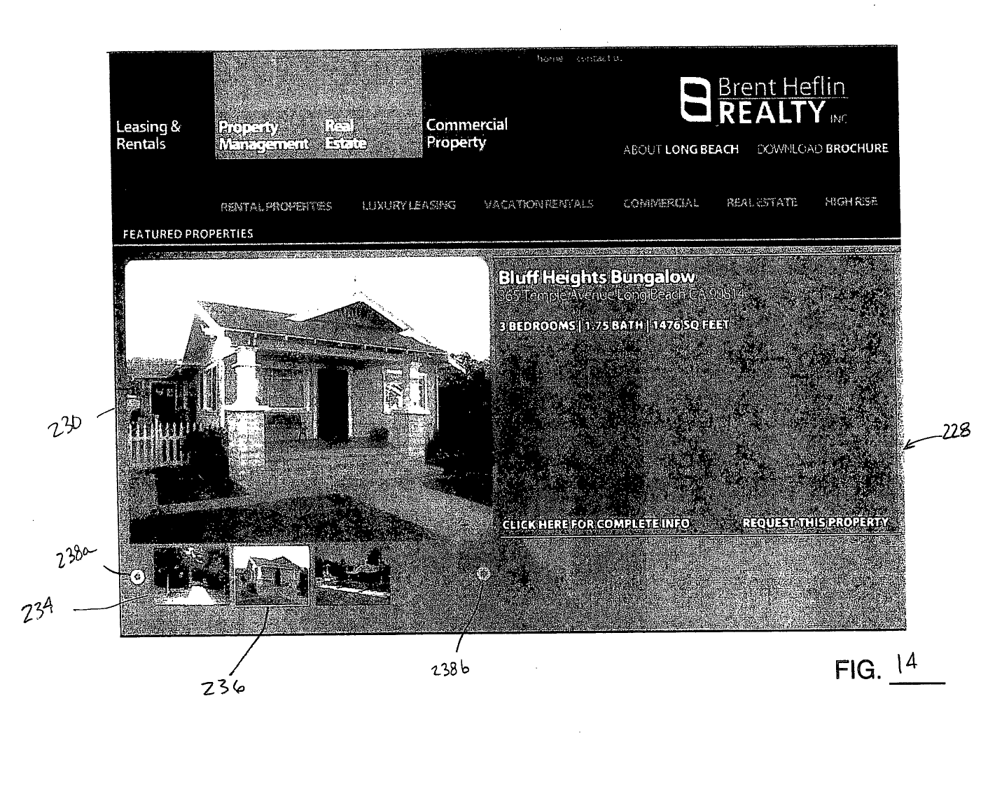

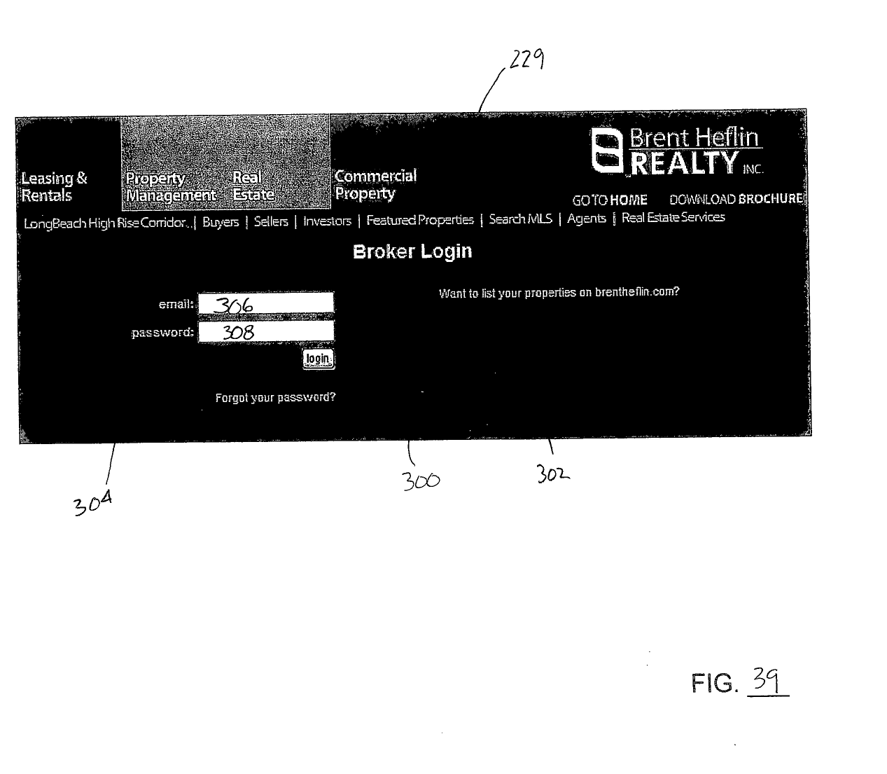

Referring to FIGS. 4, 14, and 39, the display featured property function 184 is used to collect properties 113 in the database tagged as a featured property to display on a featured properties page 228 such as the exemplary page illustrated in FIG. 14. This page is accessed through a Featured Properties link 229 such as that illustrated in FIG. 39. Thus, instead of performing a search, an end user 116 may select the show featured properties link 229 (FIG. 39) to display any properties designated as a “featured property” in the database tables 114. The featured properties page includes a selected listing section 230 with a photograph of the selected featured property along with information such as the property title, address, number of bedrooms, number of bathrooms, and square footage. This is similar to the information displayed from a simple search. As with the search results listing, a details link 232 is provided so that an end user 116 may pull up the full details of the selected featured property. Beneath the selected listing section is a secondary display section 234 including any number of thumbnail images. The end user 114 may click and drag a frame 236 to another image. Once the frame surrounds the selected image, the photograph and simple search data for the frame selected thumbnail appears in the selected listing section. A thumbnail image of the prior featured property is swapped into the spot vacated by the selected thumbnail. Lateral scroll buttons 238a, 238b scroll the thumbnail images to the left or right as desired. In that manner, images not present on the immediate screen may be accessed.

The Web Site

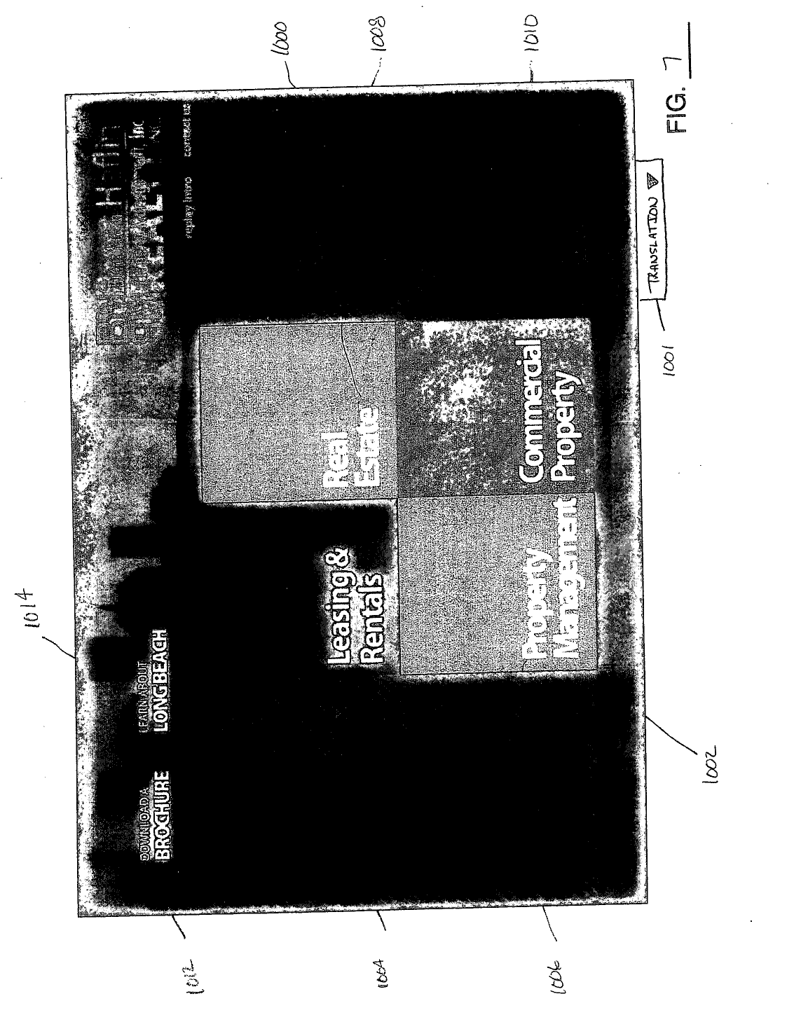

Referring to FIGS. 1 and 7, the web site 112 includes a home page 1000. The home page is generally the first page encountered by an end user 116 typing in or otherwise selecting the URL or web address for the web site in the web browser loaded into the end user computer 108. An exemplary web address is www.brentheflin.com. It will be appreciated that an introduction using such programming technology as Macromedia Flash may be used to provide an attractive lead in to the web site. The exemplary home page includes a central navigation section 1002 divided into four box shaped categories including Leasing & Rentals 1004, Property Management 1006, Real Estate 1008, and Commercial Property 1010. In addition, the home page includes a brochure link 1012 in the upper left comer for downloading a printable brochure about the realty agents managing the web site 112. A local interest link 1014 is also provided adjacent the brochure link. In this example, the local interest link is entitled “Learn About Long Beach”. The function of this link will be described below in more detail.

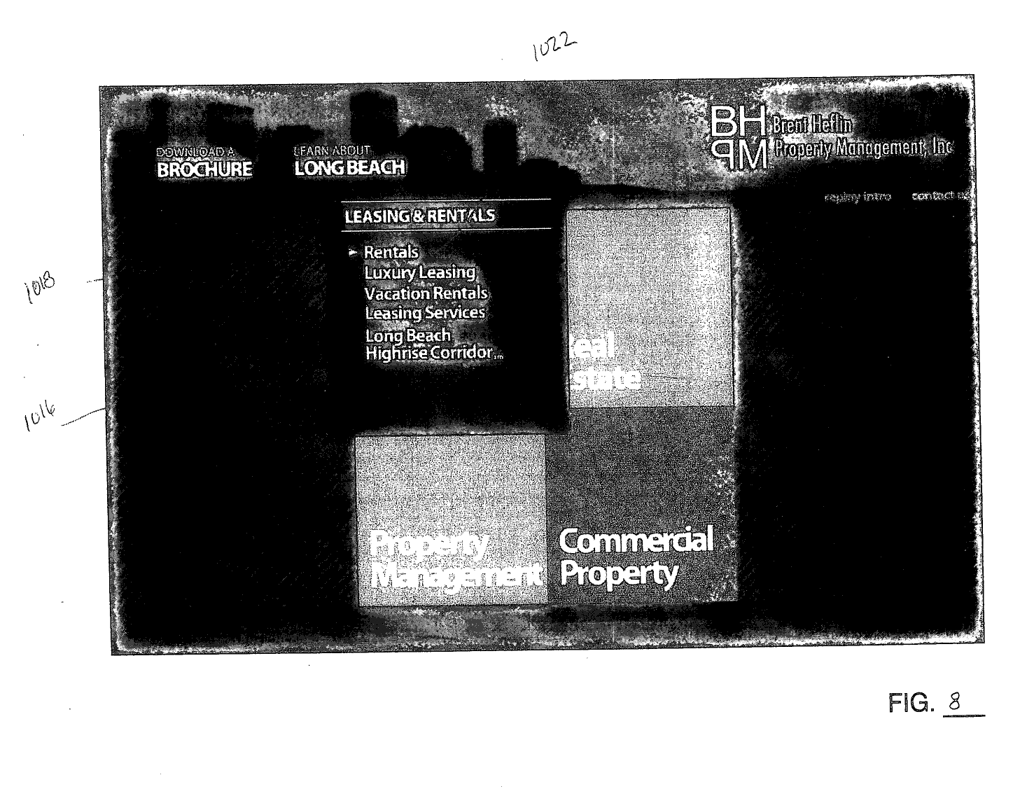

Referring to FIG. 8, the Leasing & Rentals section 1004 expands into a listing of selectable services 1016 when a cursor is moved over the box. In this example, the Leasing & Rentals selectable service links include Rentals, Luxury Leasing, Vacation Rentals, Leasing Services, and a link to a group of related properties, in this example, named Long Beach High Rise Corridor^{SM}. Each of these services is associated with a sub-level web page that may be accessed by moving the selector arrow 1018 next to the desired service. In this example, the pages pertaining to the Rentals link will be described although it will be appreciated that the other service links may function in a similar manner.

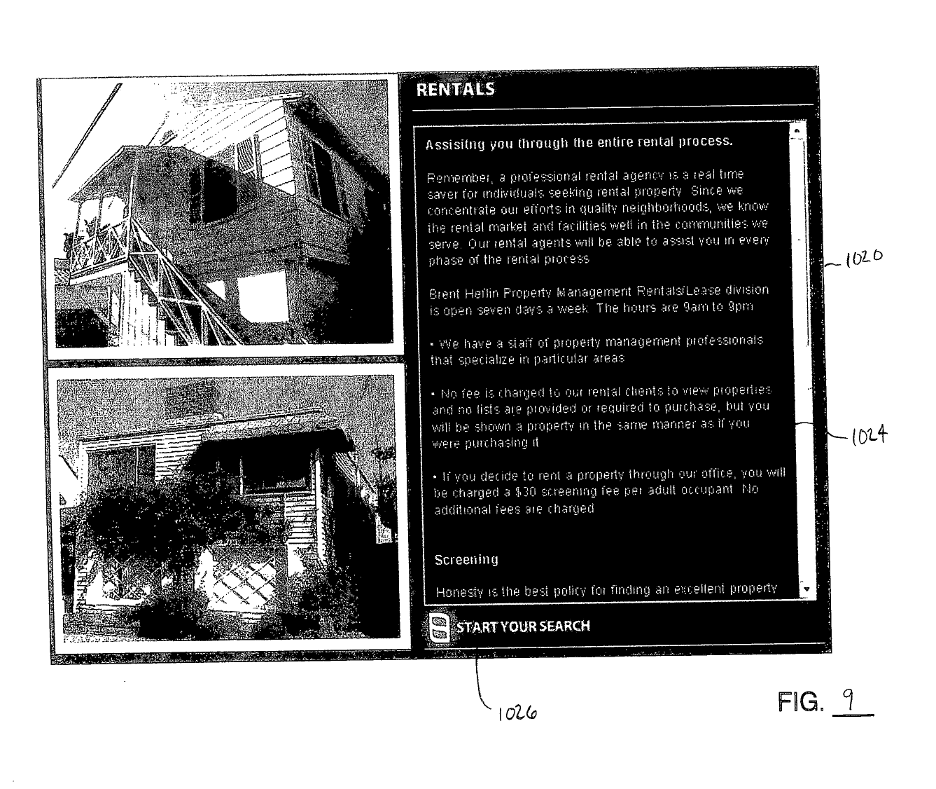

Referring to FIGS. 9 and 10, the Rentals page 1020 accessible via the Rental link 1022 includes a general description of the rental search process 1024 and a start search link 1026. Selection of the start search link will cause a simple search page 194 (FIG. 10) to load in the end user's browser window on the display device 109. The simple search page 194 includes a number of text entry and drop down boxes for inputting search criteria such as category of property, city, state, zip, neighborhood, price range, number of beds, and number of baths. For the convenience of the end user, conventional drop down boxes may be used (FIG. 10B) as for the exemplary drop down box 1029 for number of beds. The simple search page 194 includes a search properties button 202 that the end user 116 may select to start the search function after the desired search parameters have been input or selected into the simple search page form. For a more advanced search, the end user may select the advanced search link 1030 (FIG. 10A).

Referring now to FIG. 11, a search results listing page 201 is displayed after a search properties button is selected. If no property data stored in the property table 126 (FIGS. 1 and 2) matches the search criteria, then a “No Results Found” message is displayed. However, if at least one match is found in the database 114, then the results are displayed on this page 201. If more than one result is located, then the results are displayed in a vertically aligned arrangement and span from one side of the display screen to the other. For example, the search results listing in FIG. 11 show three results corresponding with three property listings. Each listing 1032a, 1032b, 1032c includes a photograph of the property, 1034a, 1034b, 1034c, respectively. Also included is the address of each property 1036a, 1036b, 1038c, respectively. A quick glance set of information including price, number of beds, number of baths, and square footage are provided near the upper right hand corner of each listing. These are designated 1038a, 1038b, and 1038c, respectively. As discussed above, each listing also includes a details link 204. Selection of this link will cause a property details page 206 to appear on the end user's display device 109.

Referring now to FIG. 12, assuming the first listing 1032a is selected, the property details page 206 includes the same detail data as on the search results listing page 201 at 1036a and 1038a. In addition, there is a primary photograph section 210 and a thumbnail photograph section 212. In this example, there is one primary photograph in the primary photograph section and five thumbnail images in the thumbnail section. Selecting the image in the primary photograph section results in the display of an enlarged image of the primary photograph. Selecting a thumbnail photograph by moving a cursor over the thumbnail image and depressing a mouse button (not shown) switches the photograph in the primary photograph section with the selected thumbnail image.

With continued reference to FIG. 12, set beneath the respective photograph sections 210 and 212, is a basic description section 214. This section may include a written description concerning the property as entered into the description field in the database 114. In addition, to the right of the written description is an “at a glance” section 216 that describes the details such as category, type, neighborhood location, year built, parking/garage, lot size, and status, if these details are known and stored in the database 114. Beneath these two sections is the lot features section 218 where any selected lot features stored in the database will be displayed. Scrolling downwardly from the lot features section, the end user will encounter the amenities section 220. This section lists all known amenities as determined by the database that the selected property includes. At the bottom the property details page 206 is the community features section 222. This section will display any community features stored in the database. The property details page may also include a virtual tour link 224 and a MLS link 226. The virtual tour link accesses a web site or multi-media program routine that may include a walkthrough video of the property or allows the end user to select a photograph and rotate the view 360 degrees. The MLS link may enable the end user to view the information on the MLS page over the network.

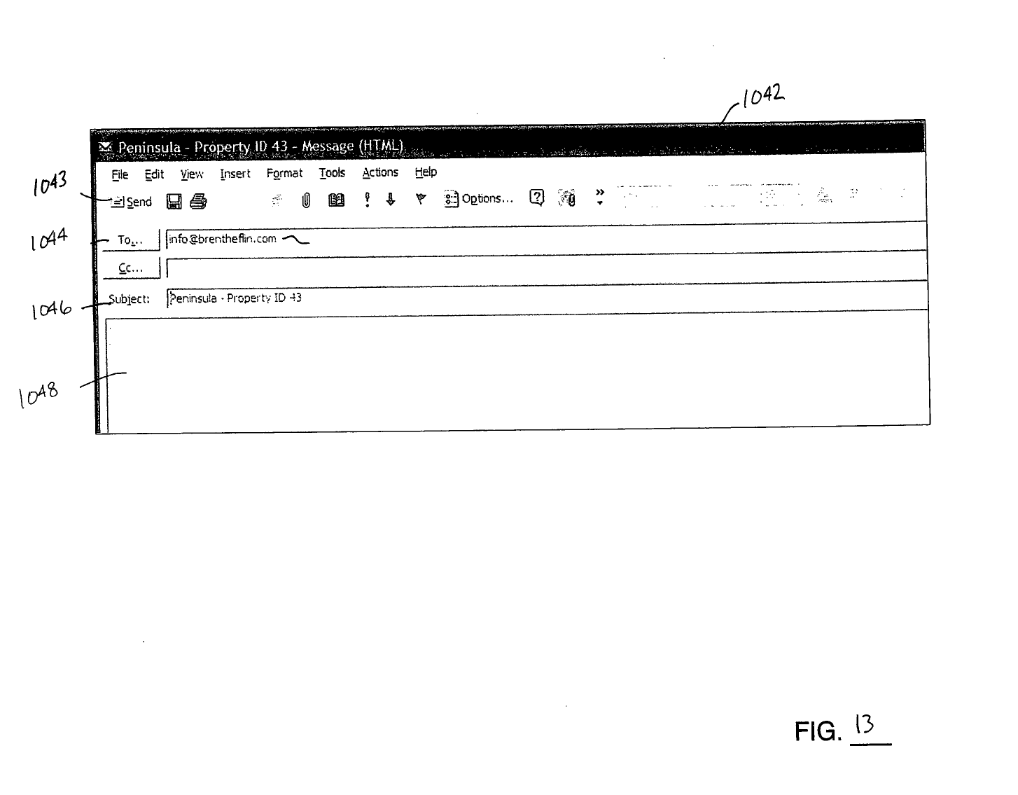

With continued reference to FIG. 12, the property details page 208 also includes a contact link 1040. Selection of the contact link will cause an email form 1042 to display on the end user's display screen 109. An exemplary email form is displayed in FIG. 13. An autofill function is used to fill in the To: line 1044 and the Subject: line 1046 of the email address. The To: line is filled in with the email address of the broker or agent responsible for conducting the realty transaction such as showing and managing the rental property. The subject line is preferably automatically filled in with a property identifier matching the property selected by the end user 116. A text input box 1048 is provided below the Subject line to allow the end user to type in a request for further information from the addressee or other message.

With reference now to FIGS. 15A and 15B, an advanced search page 198 expands upon the available search criteria that may be entered into the simple search page 194. The advanced search page includes a number of pull down menus, text entry boxes, and check boxes for selecting and entering search criteria to narrow the property search. The advanced search page is divided into four sections: a General Criteria section 1052, A Lot Features section 1054, an Amenities section 1056, and a Community features section 1058. The General criteria section includes text entry boxes for the zip code and city. Pull down menus are provided for the category (rental, etc.), state, minimum square feet, number of beds, number of floors, type (single family home, etc.), neighborhood, price range (from and to), age of home, number of baths, and parking/garage. The end user 116 may type a zip code and city into the respective text entry boxes. The end user may also select an arrow on each of the pull down boxes and scroll down to the desired selection to choose a search criteria for each category or just those categories that the end user desires to conduct a search on.

The Lot Features section 1054 is positioned on the advanced search page beneath the General Criteria section 1052 and includes a pull down menu for Lot Size on the left hand side of the section and then includes three columns of check boxes that may be selected by clicking over the box with a mouse cursor. The exemplary Lot Features check box categories as illustrated in FIG. 15A include: Gated, River View, Ocean View, Water View, Two on One, Corner Lot, Cul-De-Sac, Golf Course Lot, Peek A Boo Ocean View, Waterfront, City Light's View, Mountain View, and Boat Dock.

Set below the Lot Features section 1054 is the Amenities section 1056. The exemplary Amenities section illustrated in FIG. 15B includes three columns of thirteen check boxes. The first column of check boxes includes the following categories: Basement, Central Air, Den/Office, Swimming Pool, Family Room, Ocean View, Gourmet Kitchen, Formal Dining Room, Master Bedroom, Laundry Hookups, Oven, Hot Tub, and Double Oven. The middle column includes check boxes for the categories of: Fireplace, Forced Air, Hardwood Floor, Disability Features, Laundry Room, Balcony, Refrigerator, Plantation Shutters, Community Laundry, Washer/Dryer, Convention Oven, Laundry Chute, Laundry Area. The rightmost column includes check boxes for the categories of: Tile Floors, Berber Carpet, Dining Area, New Carpet, Breakfast Nook, Kitchen Nook, Granite Counters, Ceiling Fans, Dishwasher, Microwave, Range Top, Marble Flooring, and Mock Fireplace.

The bottom section on the Advanced Search page 198 is the Community Features section 1058. This section includes three columns of three check boxes. The left hand column includes check boxes for the categories of: Clubhouse/Rec. Room, Exercise Area, and Golf. The middle column includes check boxes for the categories of: Recreation Facilities, Security Features, and Senior Community. The right hand column as viewed in FIG. 15B includes check boxes for the categories of: Spa/Hot Tub, Swimming Pool, and Tennis. Centered in the Community Features section and beneath the middle column is a Search Properties button 1060. Selection of this button initiates a search based on the criteria input above in the four sections.

With reference now to FIGS. 7 and 16-22, from the Home Page 1000, or upon selection of a link to any of the selectable services 1016 listed in the categories of the central navigation section 1002, the end user 116 may access a local interest link 1014 leading to a series of sub-level web pages designed to inform an end user about the local area in which the properties reside. These include information about local lifestyle, local history, neighborhood listings, and a links page to web sites of local interest. Perusing this set of web pages may assist end users, particularly those unfamiliar with the area, in learning more information about the community in which they are planning to reside. This may be especially helpful for persons looking to relocate from a distant locale. This is a time saving feature to assist the end user in gaining familiarity with the local area and deciding whether the area would be a good fit for their goals.

When the end user 116 selects the local interest link 1014 from the home page 1000, the end user is presented with a main local interest page, generally designated 1062. This page includes a series of links to other related pages including a related property link 1064, a neighborhoods link 1066, a local lifestyle link 1068, a local history link 1070, and a link to a listing of community related links 1072, including for example information on local business, entertainment, government services and the like. When the end user is viewing any of the property related or other information available through any of the selectable services 1016 included in the categories of the home page 1000, e.g. 1004, 1006, 1008 and 1010, he or she is similarly presented with a link to the local interest page 1062 and/or its related pages, e.g. 1064, 1066, 1068, 1070 and 1072. Through these features, the end user is presented with comprehensive information about the local community, which is made available at all times for selectable consideration in determining whether he or she wishes to become a prospective resident. In this manner, it is further contemplated that an end user primarily seeking information about a local community may also find his or her way to the web site 112 due to its comprehensive local community focus, and then, while considering the merits of becoming a prospective resident, may then develop an ancillary interest in properties available in the community through the site.

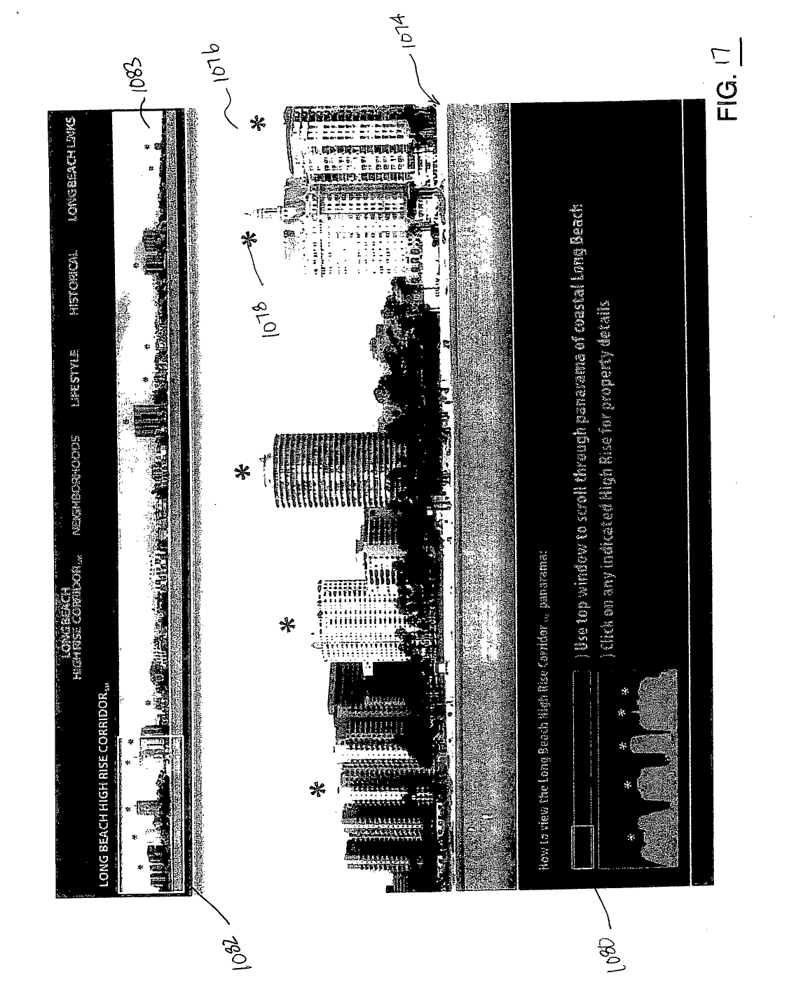

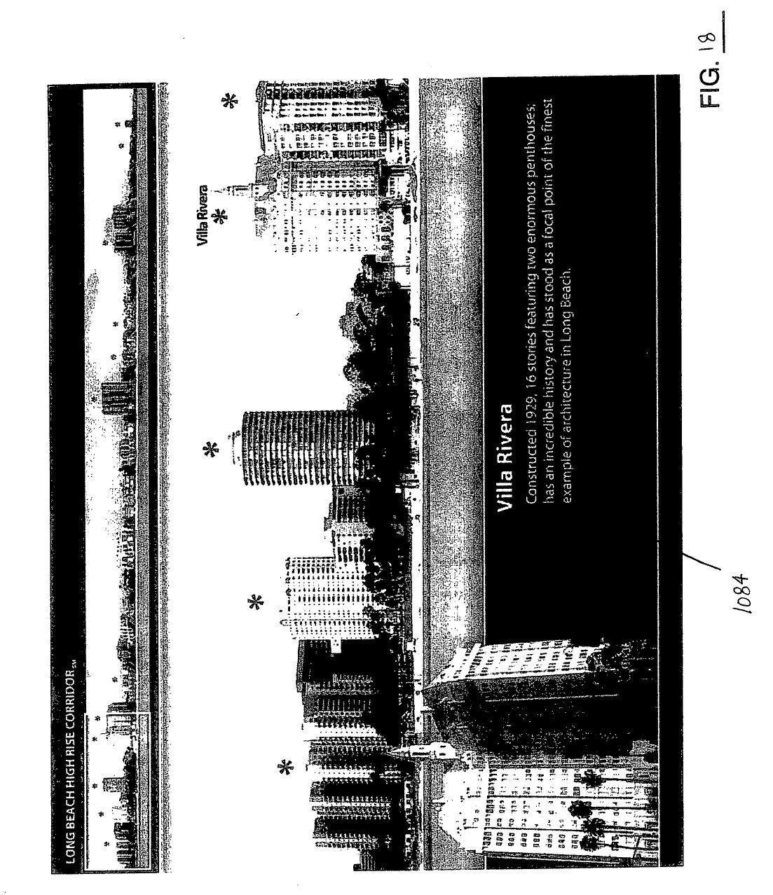

Turning now to the details of the local interest page 1062, the related property link 1064, when selected by an end user, causes a panoramic display page, generally designated 1074, and exemplified in FIG. 17 to display on the end user's monitor 109. The panoramic display page is generally reserved for a special or landmark group of buildings or other properties and displays the properties in a panoramic view 1076. In this example, the buildings represent the Long Beach High Rise Corridor^{SM}, a group of properties generally running along Ocean Boulevard in Long Beach, Calif., and forming a skyline. Information on these properties is stored in the database 114. Above each building is an asterisk as exemplified at 1078. Below the panoramic view 1076, an instruction window 1080 is located. By sliding a scroll window 1082 above the panoramic view along a mini panoramic window 1083, those properties outside of the panoramic view may be displayed. Selection of the asterisk 1078 above a property results in the instruction window 1080 changing to an information window 1084 (FIG. 18) providing additional detail about the building.

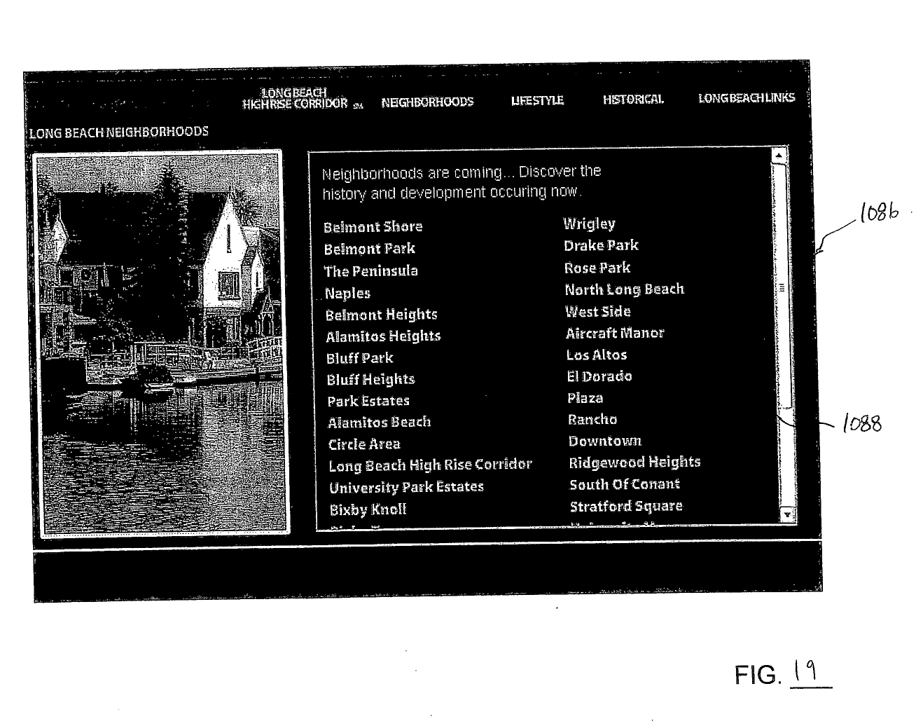

Referring now to FIG. 19, a neighborhoods page, generally designated 1086, lists the neighborhoods 1088 for the geographic area covered in the database 114. In this example, the neighborhoods of Long Beach, Calif. are listed. It will be appreciated that each individual neighborhood listing may be selectable to display information relating to the specific neighborhood. It is also contemplated that selection of a given neighborhood will cause a map to display depicting the neighborhood, or some other vehicle to orient the user to the location of the neighborhood. The neighborhood data may be stored in the neighborhood table 133 (FIG. 1), which is periodically updated to reflect properties currently available in each neighborhood.

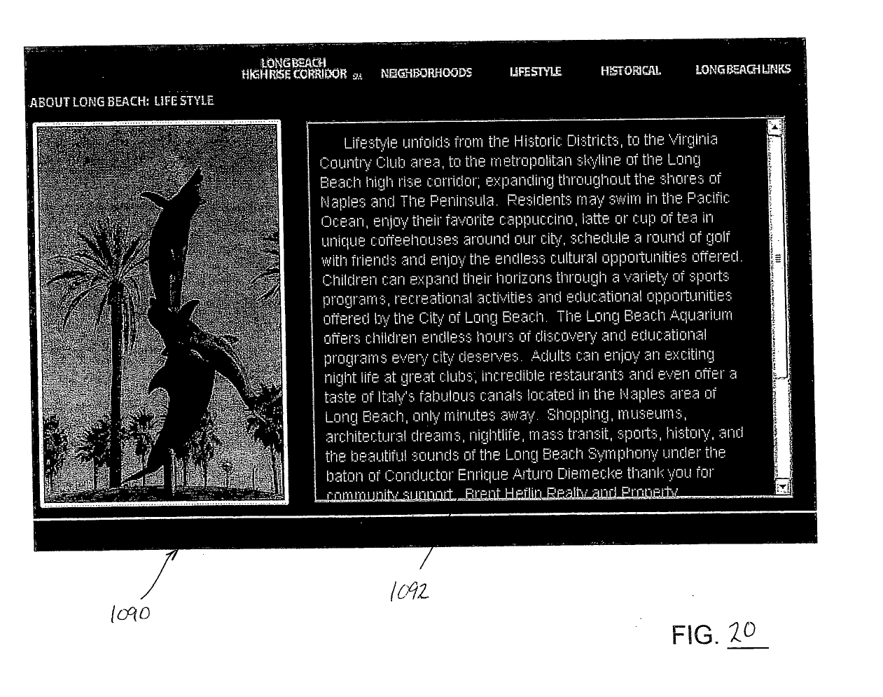

With continued reference to FIGS. 7 and 20, selection of the local lifestyle link 1066 by an end user will cause a local lifestyle page 1090 to appear on the end user's screen 109. This page includes a text box 1092 describing the community and recreational activities available, and the general cultural environment of the community or geographic region relating to properties stored in the database. The local lifestyle data is stored in the local culture data table 129 (FIG. 1).

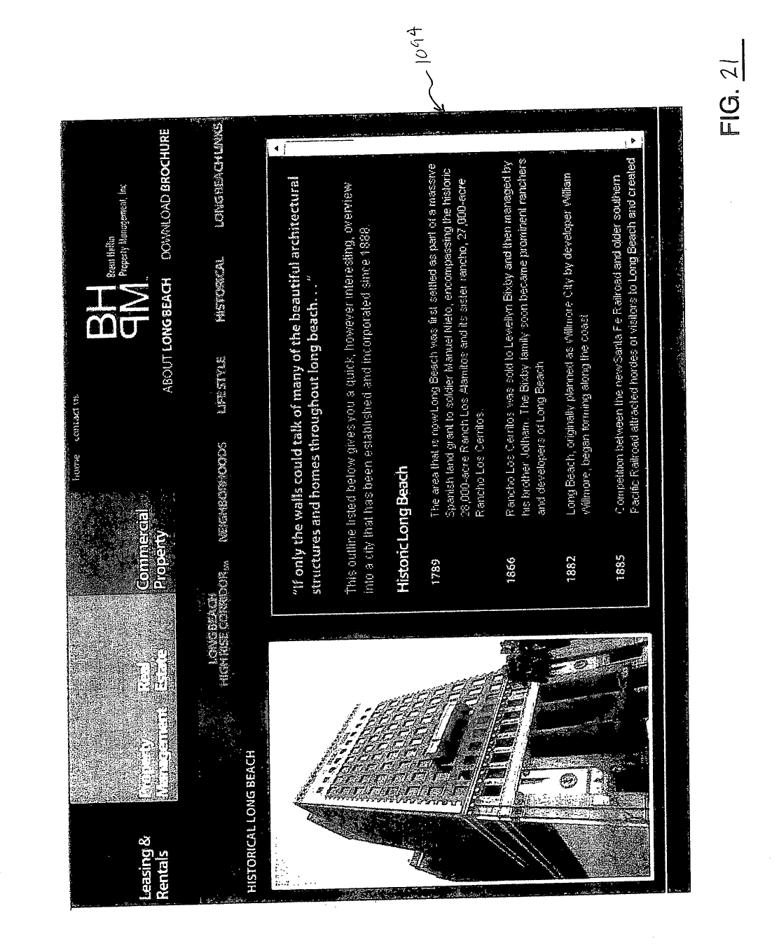

A local history page 1094 (FIG. 21) is accessible via the local history link 1070. This page outlines the history of the selected community or geographic region such as its first settlement, incorporation, or other significant historical events. While this information is displayed in chronologic listings in the depicted local history page, it may be presented in any appropriate or desired manner. Local history data is stored in the local history data table 131 in the accessible database (FIG. 1).

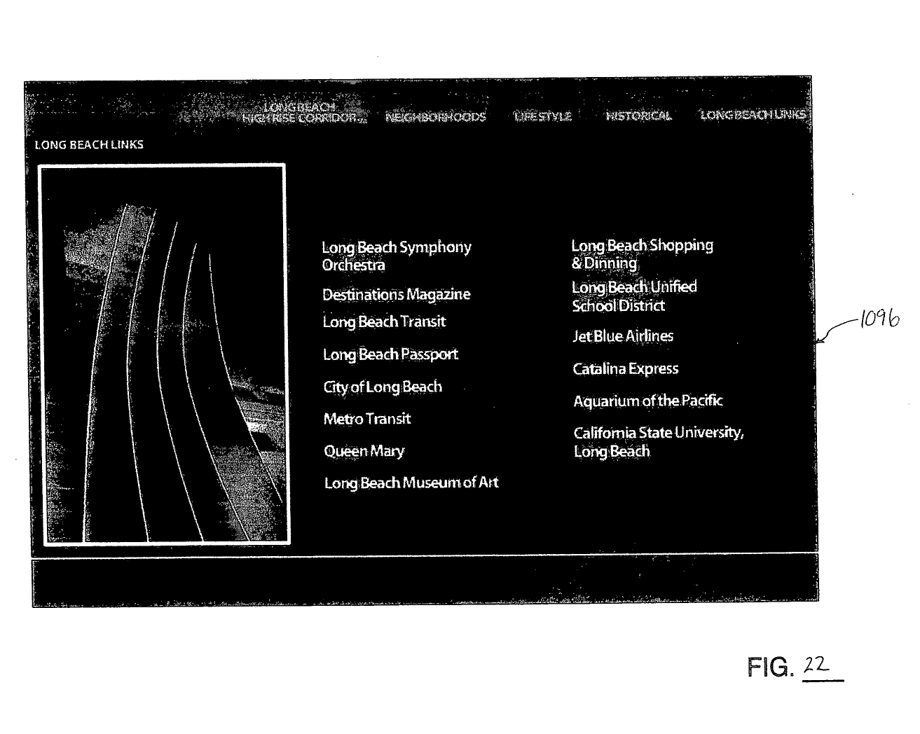

An assembly of links to local businesses, governmental entities, travel providers, recreational and entertainment activities or the like may be collected by the system administrator 104 and will display on a community related links page 1096 (FIG. 22) when the user selects a link 1072 to this page.

Together, this group of pages 1062, 1074, 1086, 1090, 1094, and 1096 cooperate to provide comprehensive information about a specific community or geographic region, such as Long Beach in this example, to assist a prospective resident in determining relocation advantages.

Backend Administration

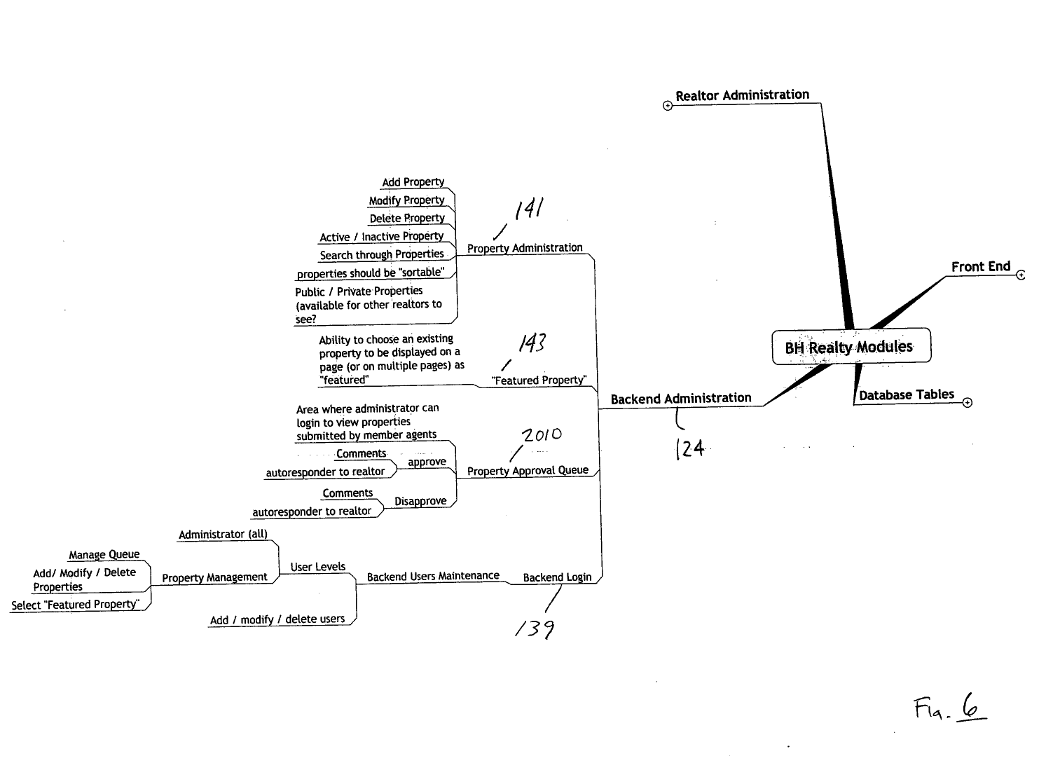

Referring now to FIGS. 1 and 6, the Backend Administration module 124 provides functionality for property administration 141, featured property displays and information 143, a property approval queue 2010, and a backend login 139. Through the Property Administration function 141, the user may add, modify, or delete a property listing, render the property listing active or inactive for access or viewing, search the properties database, and segregate properties into a public or private listing (restricted access or viewing). As part of the Backend Administration features, the user may also select particular properties to be displayed on a dedicated Featured Property Page 228.

A Backend Login routine 139 (FIG. 6) allows the web site administrator 104 to enter the web site 112 to perform maintenance on the site. This may entail applying different user levels of access including an administrator level with access to all functions and web pages and a property management access level wherein the property approval queue 2010 may be accessed for approval and disapproval, to add, modify, or delete properties or select properties for display on the Featured Properties page. The Administrator can add/ modify user access, or delete users.

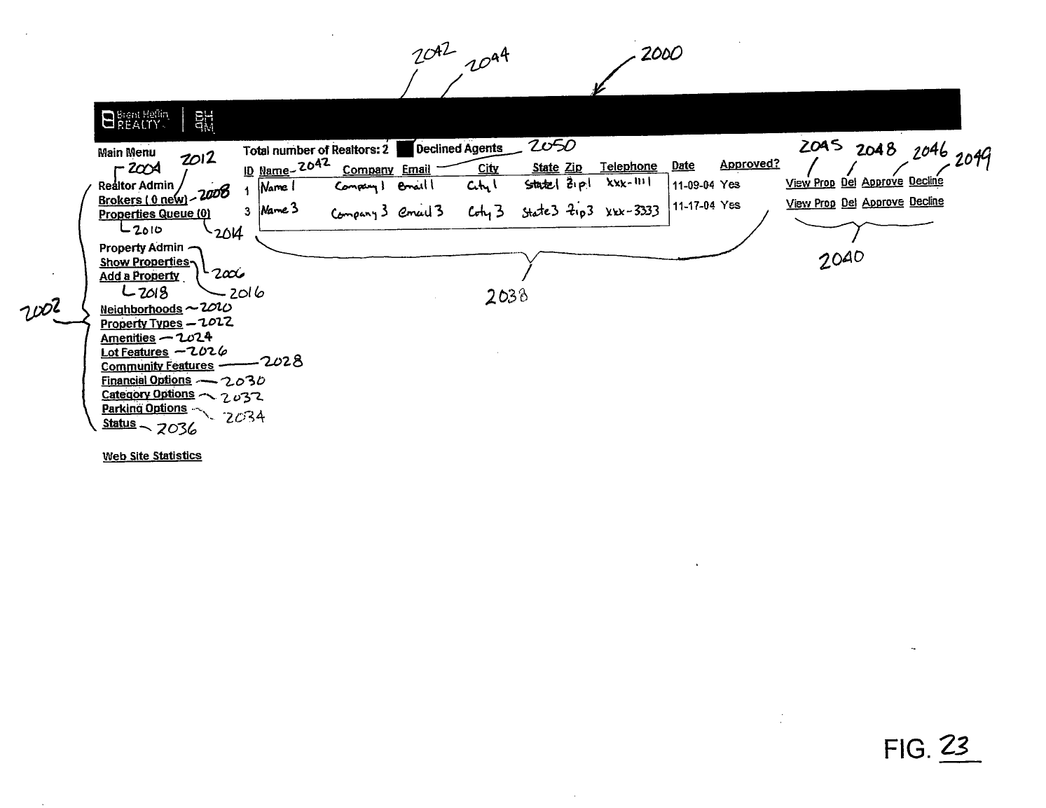

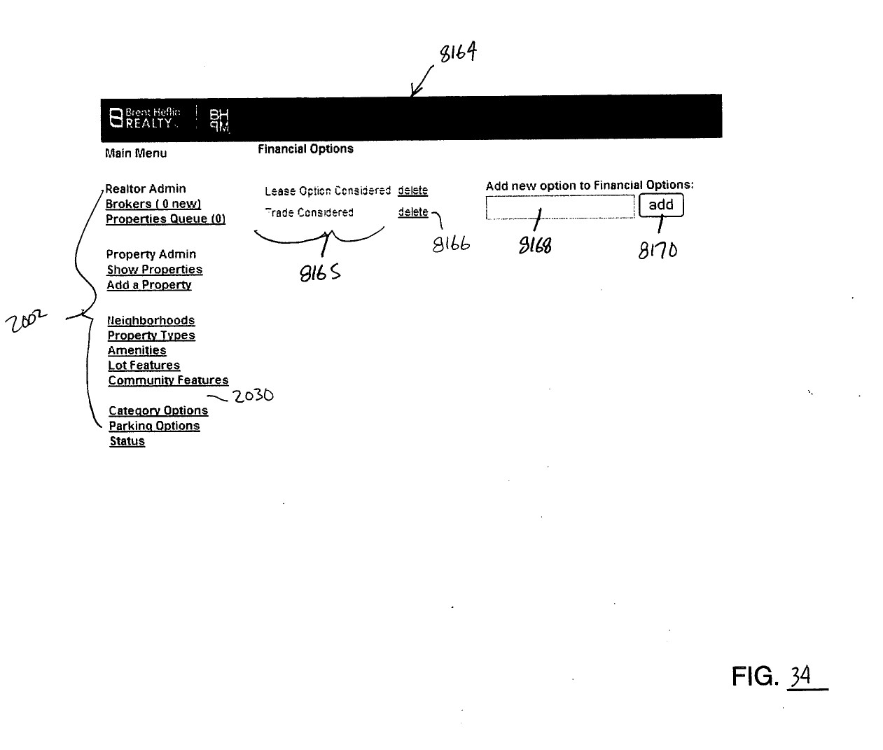

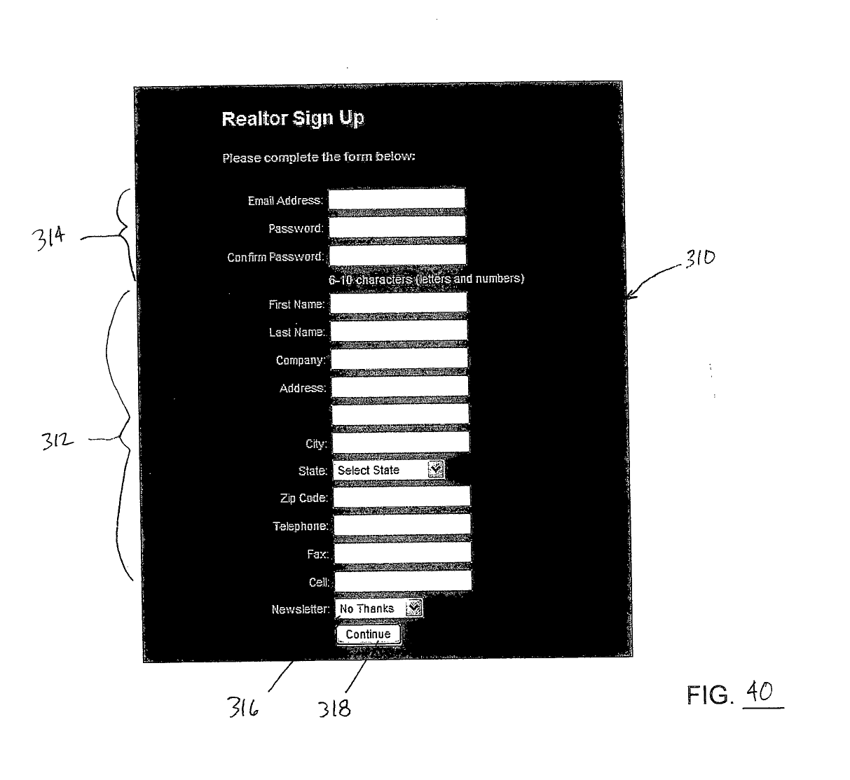

Backend administration is facilitated through a series of web pages generated by the Backend Administration module 124 (FIG. 6) guiding the administrator through the administrative tasks. Referring now to FIGS. 23-45, assuming a successful logon procedure via the backend login procedure 139 has occurred using conventional security programming techniques, the system administrator 104 is presented with Main Menu page 2000 of the backend administration module 124. Within this series of web pages, the Administrator may control the addition or deletion of realtors listed in the system, add or delete properties in the system, and further conduct property administration tasks. The Main Menu page includes a left side vertically extending navigation menu, generally designated 2002, with a Realtor Administrative Section 2004 set above a Property Administrative Section 2006, each section having a set of links to other sub-pages for conducting administrative tasks. Under the Realtor Admin section 2004, these links include the Brokers Queue link 2008 and the Properties Queue link 2010. The Brokers Queue link 2008 includes a count indicator 2012 displaying the number of brokers (agents) in the queue that have not been accepted or declined to date. Similarly, the Properties Queue link 2010 includes a property count indicator 2014 displaying the number of properties in the queue that require administration.

Under the Property Admin section 2006, the sub-links include a Show Properties link 2016, an Add a Property link 2018, a Neighborhoods link 2020, a Property Types link 2022, an Amenities link 2024, a Lot Features link 2026, a Community Features link 2028, a Financial Options link 2030, Category Options link 2032, Parking Options link 2034, and a Status link 2036.

To perform administrative tasks, the administrator 104 may select a link option and perform the task associated with that option. For example, from the Main Menu page 2000, the administrator may select the Brokers Queue link 2008 beneath the Realtor Admin section 2004 heading. This will bring up the broker listing table 2038 as in FIG. 23. The table is broken into headings corresponding to a unique ID and contact information (Name, Company, Email, City, State, Zip, Telephone). The table also includes a heading for Date of entry Date and an Approved status. Each broker listed in the table is identified by a unique ID. The contact information for each broker is listed under each corresponding heading. At the end of the table are a set of action buttons 2040 including a View Prop button, a Del button, an Approve button, and a Decline button. The View Prop button may be selected to display all properties being represented by a particular broker in the same row as the button. The Del button may be selected to delete the broker listing from the table. The Approve and Decline buttons may be selected by the administrator to approve or decline the broker for a listing in the table. Approving the broker allows the brokers properties to be search using the simple or advanced search routines described herein. Declining the broker renders the broker properties inaccessible to a search through the simple or advanced search routines. For a quick glance, the total number of realtors (brokers, agents) is displayed above the table at 2042 with the total number of declined agents displayed at 2044 to the immediate right of the realtor total.

The navigation menu 2002 is displayed on the left hand side of this page as well. On this page, the administrator may view information associated with each realtor under the headings ID #, Name, Company, Email, City, State, Zip, and Telephone. These columns are sortable and selecting on the heading title results in the broker listings being sorted according to an ascending or descending order underneath the selected heading title. On this page, the administrator may select to approve or decline the broker by selecting the corresponding button in the button group 2040. If the broker has been approved, a “Yes” appears underneath the Approved heading in the row corresponding to the selected broker listing. “No” appears if the broker has been declined. The date approval appears under the Date heading.

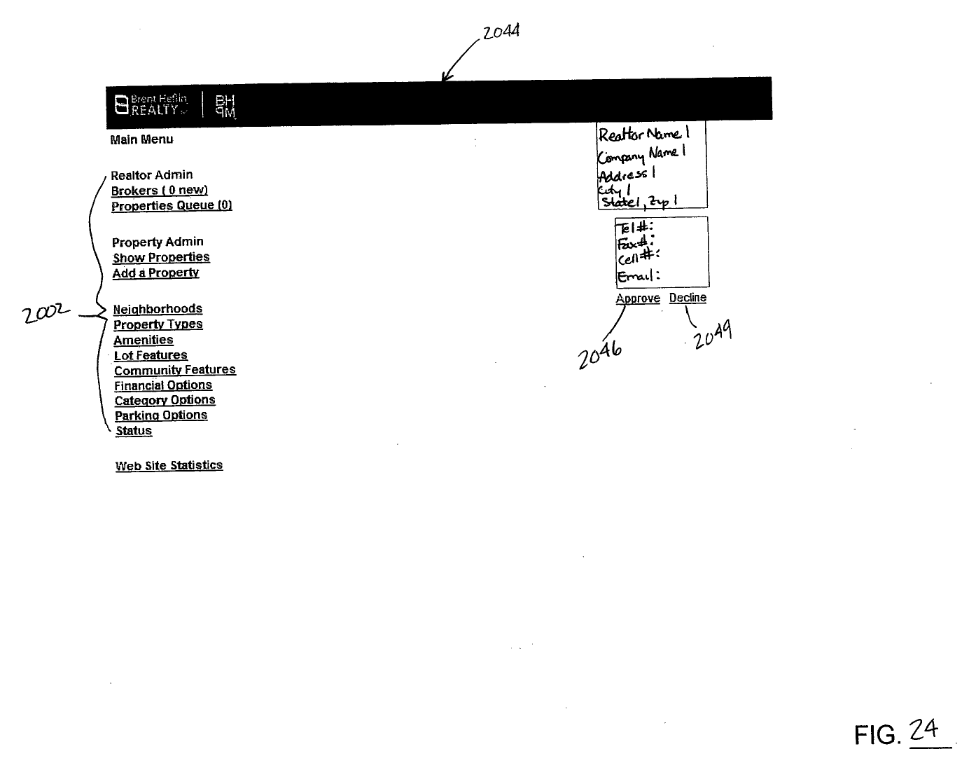

Items under the Name heading 2042 are selectable and selection of a Name such as Name1 in FIG. 23 will cause a broker contact information screen 2044 (FIG. 24) to display on the administrator's monitor 105. This screen 2044 shows the information pertinent to the selected realtor name and also includes an Approve and Decline buttons 2046 and 2048, respectively. Selection of either button sets up a status for that realtor. An approved realtor is available during a search of the database 114 while a declined realtor is not. A declined realtor may be indicated by highlighting the listing in red or other indicative marking. These buttons function the same as their counterparts on the button section 2040 on the broker listing page that is the same as the home page 2000 with the addition of the broker listing table 2038 and button section 2040.

On the broker listing page, the administrator also has the option to view the property or properties associated with each realtor listing or delete the realtor from the listing using the View Prop. link 2046 and Del link 2048, respectively.

Items beneath the Email heading 2050 are also selectable and may conveniently cause an email composition window similar to that shown in FIG. 13 to pop up on the display including the realtors email address automatically filled in so that a message may be sent without having to retype the realtor's email address.

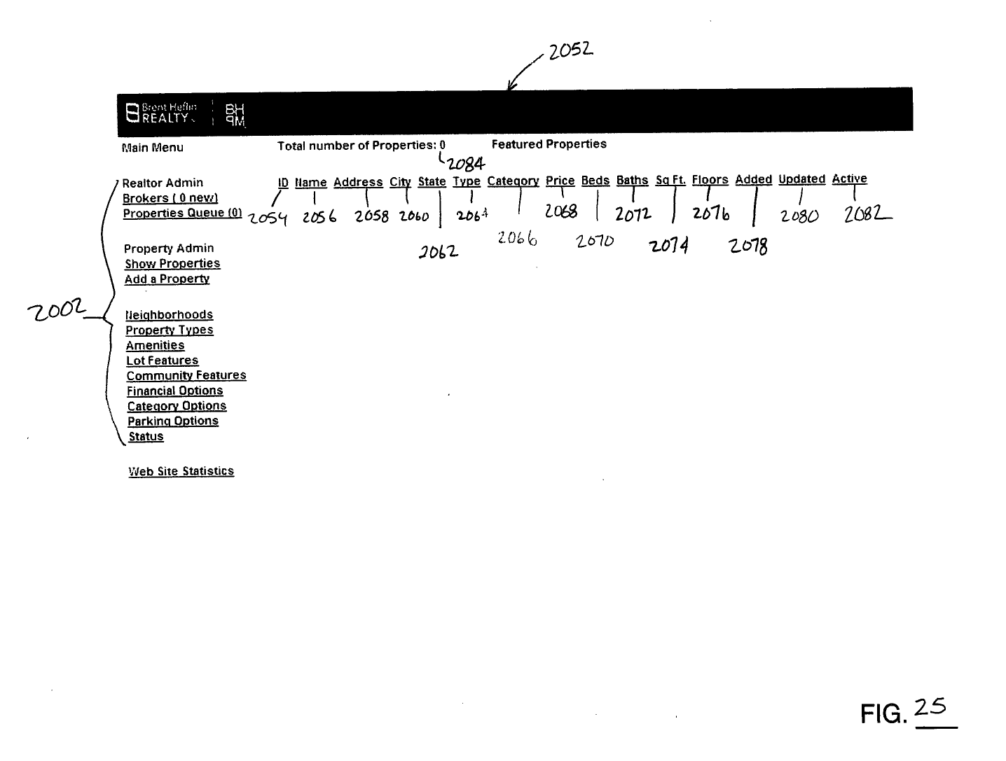

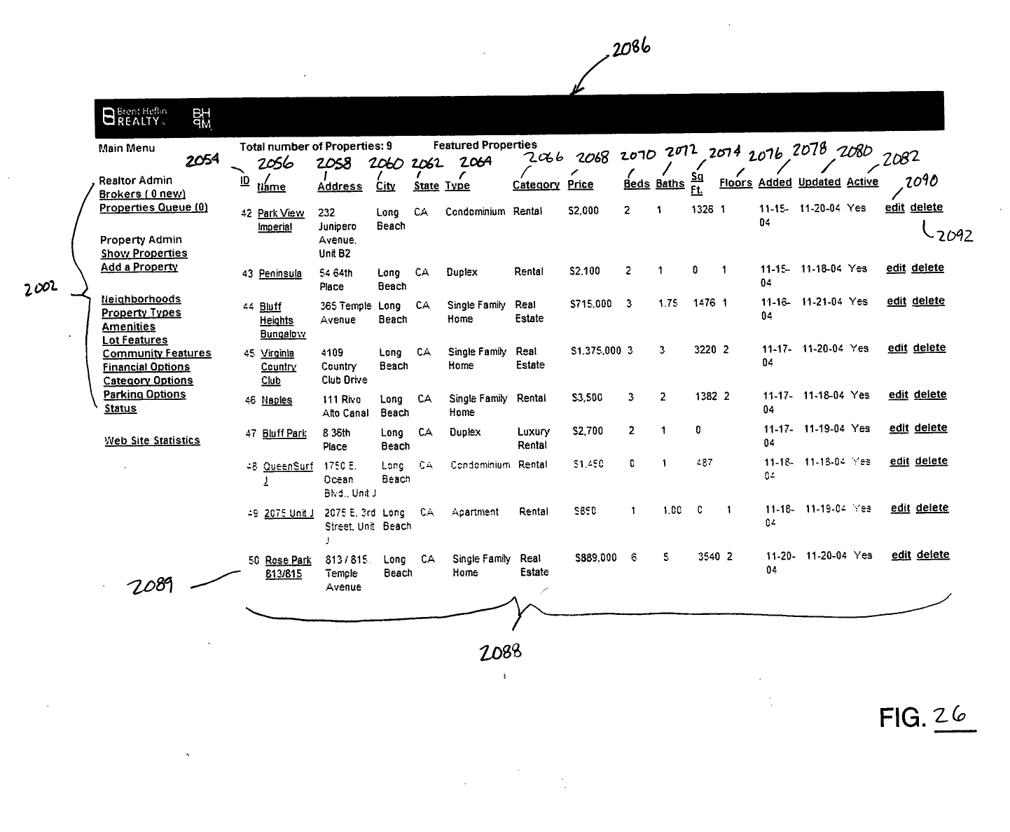

Selection of the Properties Queue link 2014 on the Main Menu page 2000 (FIG. 23) causes a web page as in FIG. 25 to display on the administrator's display device 105. The Property Queue page 2052 includes a grouping of headings including ID 2054, Name 2056, Address 2058, City 2060, State 2062, Type 2064, Category 2066, Price 2068, Beds 2070, Baths 2072, Sq. ft. 2074, Floors 2076, Added 2078 and Updated 2080. There is also an Active heading 2082 at the end of the heading column. Each property listing has a unique ID# and the associated information is displayed beneath the corresponding heading. The exemplary screen in FIG. 25 does not include any listings. The number of property listings is indicated in a property listing counter 2084. Underneath the Added heading is a date that the information was initially added. Underneath the Updated heading is the last date in which the property data in any one of the other data columns was modified. An exemplary listing with data is illustrated in FIG. 26.

With continued reference to FIG. 23, Property Admin section 2006 on the Main Menu page 2000 includes a Show Properties link 2016. Selection of this link causes a display such as that in FIG. 26. The Show Properties page 2086 includes property listing table 2088 with identical headings as in the properties queue page 2052 (FIG. 25) and like headings are numbered alike. A single exemplary property listing spans a row designated 2089. The will list the available properties from the database along with the information corresponding to headings ID# 2054, Name 2056, Address 2058, City 2060, State 2062, Type 2064, Category 2066, Price 2068, Beds 2070, Baths 2072, Sq. Ft. 2074, Floors 2076, Added 2078, Updated 2080, and Active 2082. Under an Active heading 2082, the property is described as Yes or No depending on whether the property is available. At the end of each listing is an edit button 2090 and a delete button 2092 for modifying or deleting each listing respectively. The administrator 104 may sort on the column headings such as ID#, Name. or Price for example. To delete a property listing from the table 2088, the administrator may select the delete button 2092 in the row corresponding to the listing to be deleted.

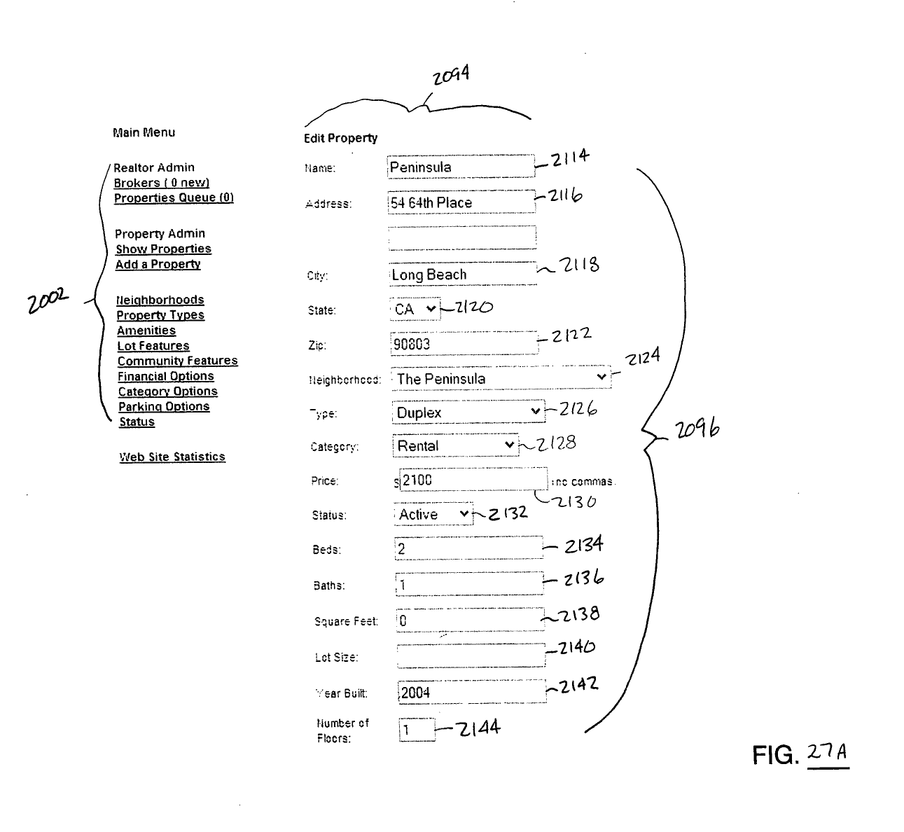

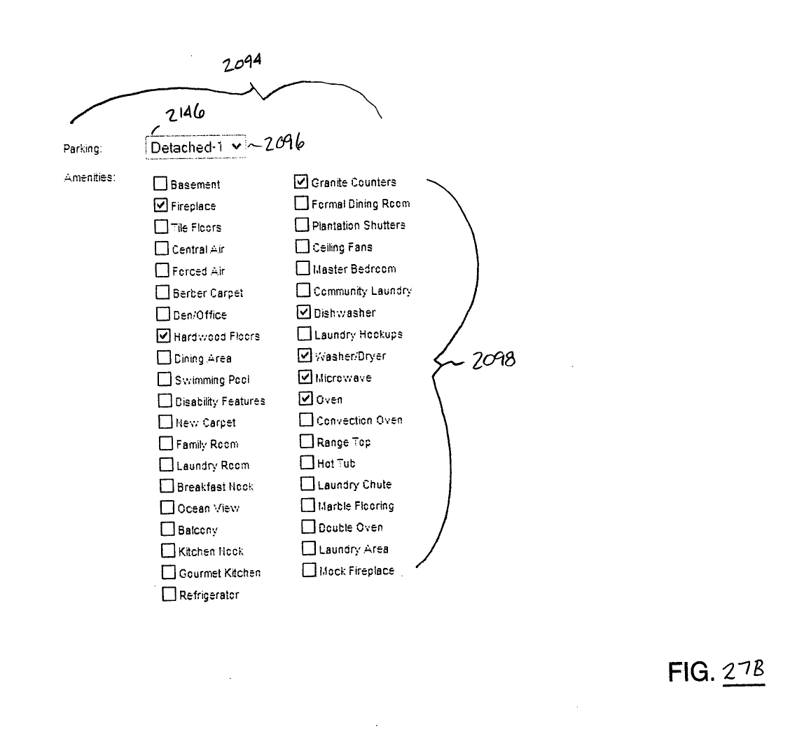

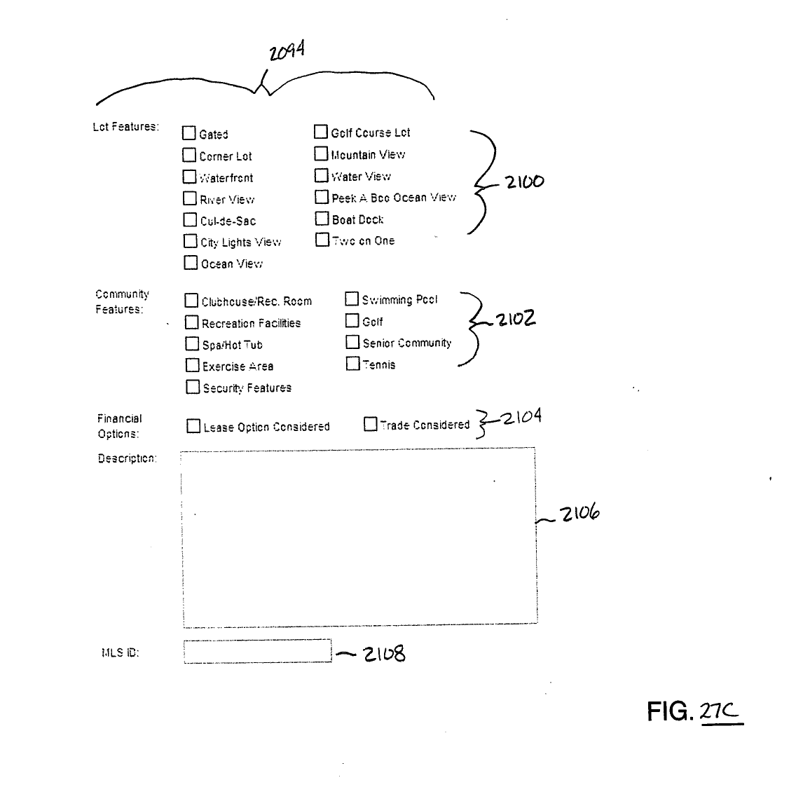

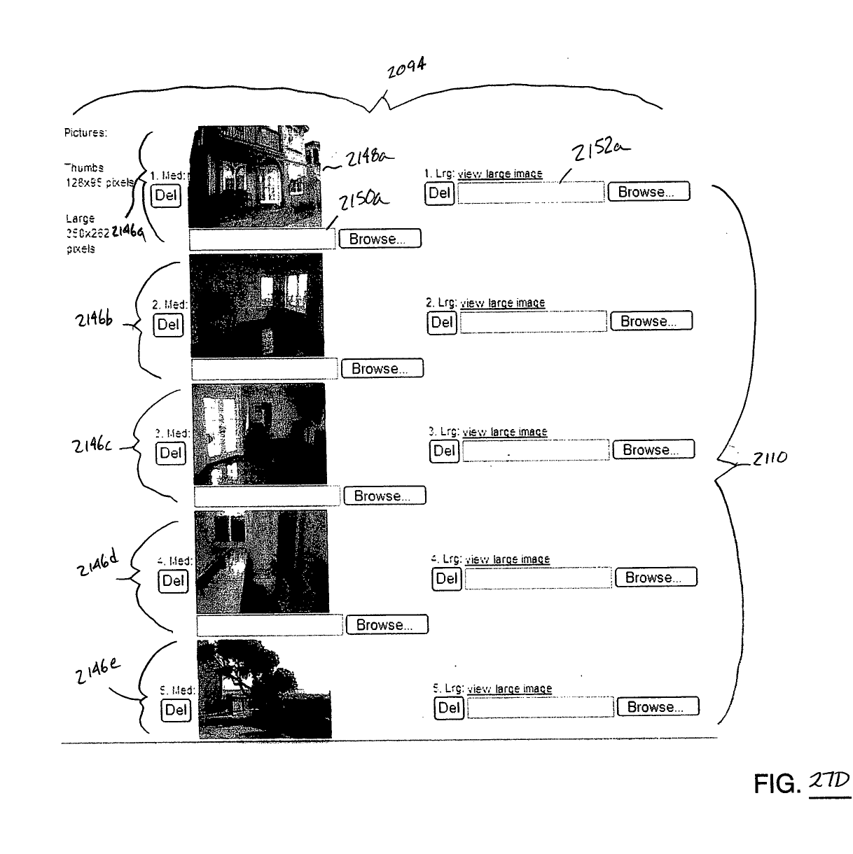

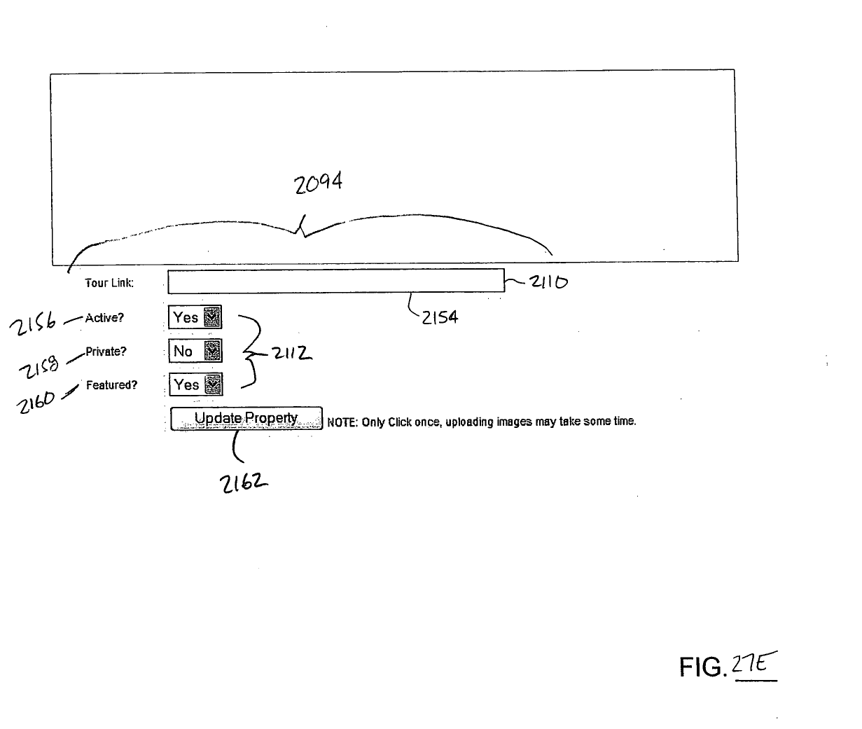

With continued reference to FIG. 26 and turning also to FIGS. 27A-27E, the administrator 104 may also edit one or more property listings. For example, as new or updated property detail information is collected by the data manager 106, this property detail information may be sent to the administrator to update the property listing table 2088. By selecting an edit button 2090 in the property listing row of the property to be modified, the administrator will cause an edit screen 2094 shown across FIGS. 27A-27E. In use, all components of the edit screen may be accessed by using a conventional scroll bar. The edit screen is divided into several sections, vertically aligned on the page. The first section is a general information section 2096 (FIGS. 27A-27B). The second section is the amenities section 2098 (FIG. 27B). The third section is the lot features section 2100 set above a community features section 2102 (FIG. 27C). The financial options section 2104 is next. Still referring to FIG. 27C, a description section 2106 is positioned below the financial options section and above an MLS ID section, 2108. A picture and tour link management section 2110 (FIGS. 27D-27E) follows the MLS ID section. Set beneath the picture management section is a tour property status section 2112.

Referring back to FIGS. 27A-27B, the general information section 2096 includes a set of vertically aligned text input boxes and pull down menus for entering property description information into the database 114. Starting at the top of screen, the exemplary general information 2096 includes a name text entry box 2114, a one or two line address text entry box 2116, a city text entry box 2118, a state pull down menu 2120, a zip code text entry box 2122, a neighborhood pull down menu 2124, a property type (Single Family Home, Apartment, Duplex, Condominium, Townhouse, Loft) pull down menu 2126, a property category (Rental, Luxury, Vacation Rental, Commercial, Real Estate) pull down menu 2128, a price text entry box 2130, a status pull down menu 2132, a number of beds text entry box 2134, a number of baths text entry box 2136, a square foot text entry box 2138, a lot size text entry box 2140, a year built text entry box 2142, a number of floors text entry box 2144, and a parking situation (Attached, Garage-1, Garage-2, Garage-3, RV Parking, Carport) pull down menu 2146.

As the property details 115 have already added to the system database 114, the information that appeared on the property listing is automatically filled in under the appropriate text entry box or pull down menu. To edit or otherwise modify any the current property details in the general section, the administrator may type the desired text in a text entry box or use the pull down menu to select an alternative descriptor.

Referring now to FIGS. 27B and 27C, the amenities section 2098 includes a two column set of check boxes including categories of basement, fireplace, tile floors, central air, forced air, berber carpet, den/office, hardwood floors, dining area, swimming pool, disability features, new carpet, family room, laundry room, breakfast nook, ocean view, balcony, kitchen nook, gourmet kitchen, refrigerator, granite counters, formal dining room, plantation shutters, ceiling fans, master bedroom, community laundry, dishwasher, laundry hookups, washer/dryer, microwave, oven, convention oven, range top, hot tub, laundry chute, marble flooring, double oven, laundry area, and mock fireplace. Next to each category heading is a check box. The current set of amenities will include a check mark in the box. The check marks may be turned on or off by selecting the check box. Similarly, the lot features section 2100 includes a two column categories and corresponding check boxes arrangement for the property descriptors including: gated, corner lot, waterfront, river view, cul-de-sac, city lights view, ocean view, golf course lot, mountain view, water view, peek a boo ocean view, boat dock, two on one. These check boxes operate in the same manner as for the amenities section check boxes.

Beneath the lot features section 2100, the community features section 2102 is another two column check box configuration with the first column including descriptors for clubhouse/rec. room, recreation facilities, spa/hot tub, exercise area, security features and the second right hand column including descriptors for swimming pool, golf, senior community, and tennis. The financial options section 2104 includes side by side check boxes labeled lease option considered and trade considered.

Still referring to FIG. 27C, the text description section is in the form of an enlarged text entry box into which the administrator may input a description of the property in further detail or provide information not available on the remainder of the edit entry form 2094. The MLS ID section 2108 is also a text entry box for receiving the MLS ID of the property, if known.

Turning now to FIGS. 27D, the picture management section 2110 is used for inputting a retrieval path to the storage area of photographs or digital images for each property listing. In this example, there are five picture storage sections, 2146a, 2146b, 2146c, 2146d, and 2146e, from top to bottom, respectively. Each picture storage section includes thumbnail image 2148a and a thumbnail retrieval path text entry box 2150a. The administrator may enter a file path into the thumbnail retrieval path text entry box where the thumbnail image 2148a is located in the database 114 or other transaction server storage media. Each picture storage section also includes a large image retrieval path text entry box 2152a for receiving the file path information for the enlarge picture version of the thumbnail image 2148a. Thus, an administrator may alter the thumbnail images and enlarged pictures associated with each property by altering the respective file path names. The picture management section 2110 also includes a tour link path retrieval text entry box 2154 (FIG. 27E). This box may receive a link such as a URL or web address or other suitable file path name for retrieving a virtual tour of the property. A virtual tour may include a 360 degree panoramic view of each room or appear as a walkthrough of the property and the surrounding grounds.

With continued reference to FIG. 27E, status section 2112 includes drop down menu boxes including an Active label 2156, a Private label 2158, and a Featured label 2160. These pull down menus provide a Yes/No option. For example, the pull down menu next tot he Active label 2156 may be selected to choose from the YES or NO option. Yes equates to the property listing being currently available for renting, leasing or other real property transaction. A No selection means the associated property listing is not available. This indicator appears underneath the Active heading 2082 on the Show Property page 2086. The pull down menu next to the Private label 2158 may also be selected and a choice of YES/NO enabled. The third pull down menu in the status section 2112 is for indicating whether the property is to be available on the Featured Properties page 228 (FIG. 14) described above and includes a YES/NO setting as well. At the bottom the edit form 2094, an update property button 2162 is located. Selection of this button will transmit all of the information in the edit form fields to the database 114. The date under the Updated heading 2080 on the Show Properties page 2086 will reflect the date on which the update property was selected.

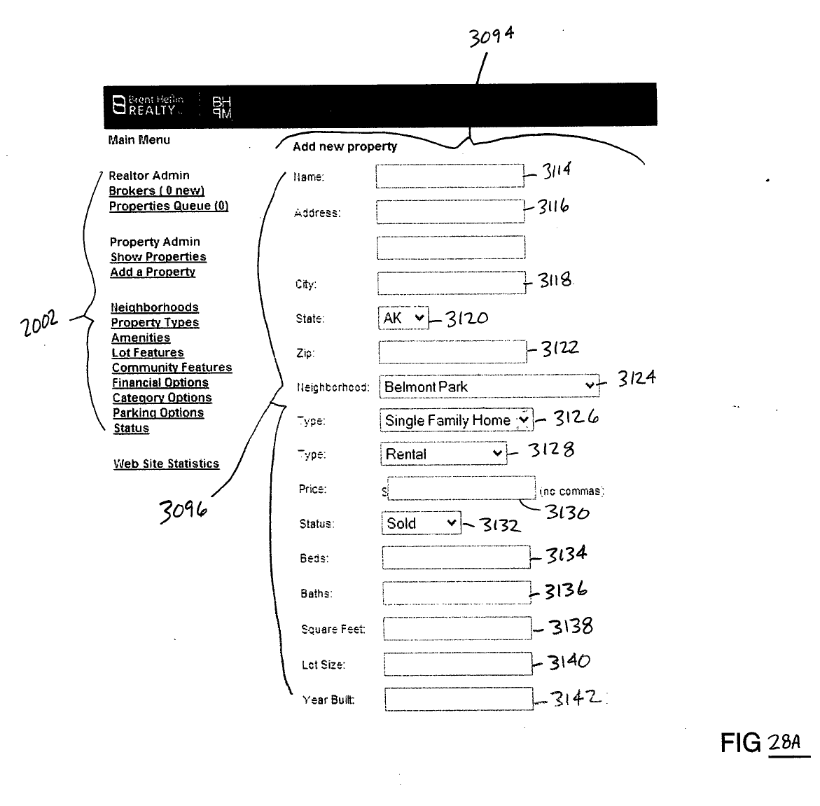

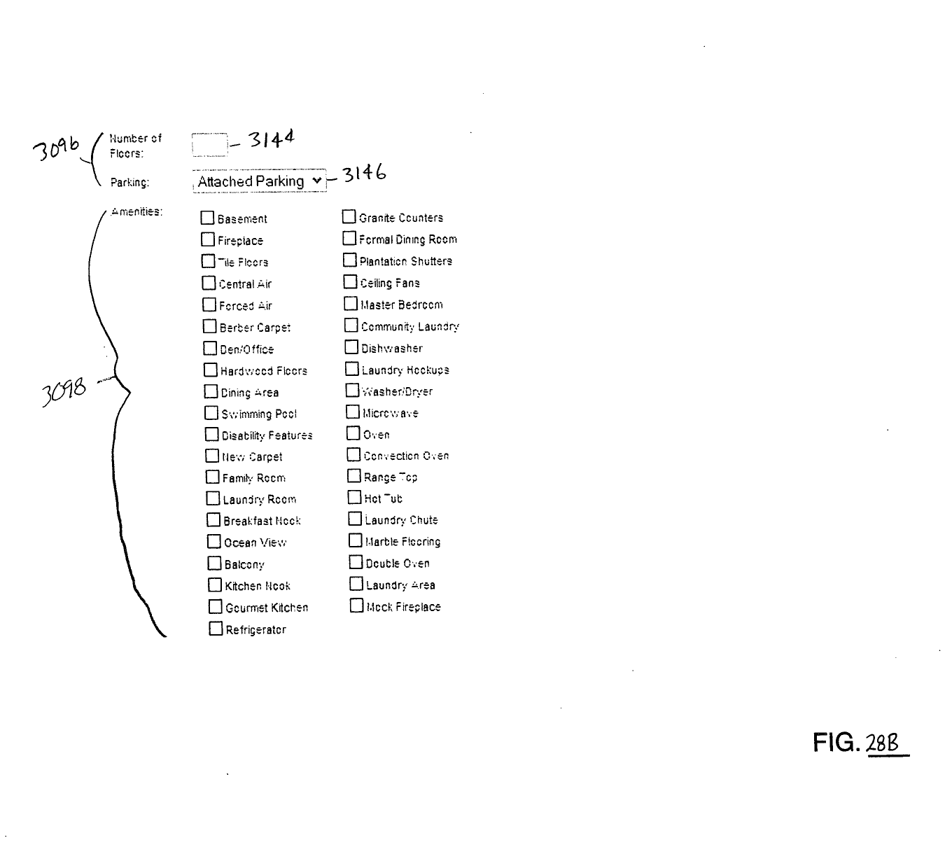

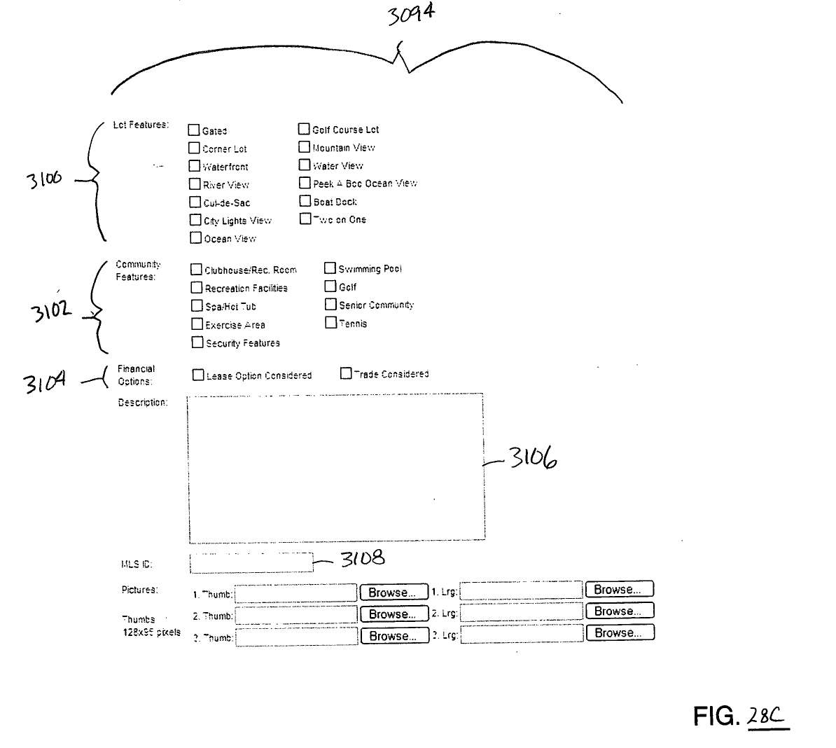

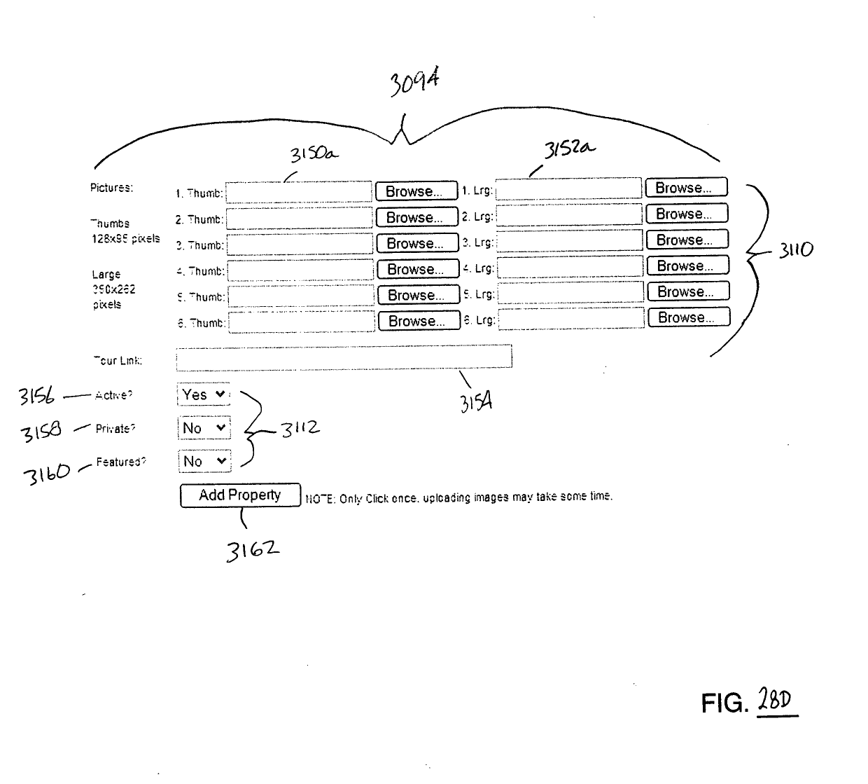

Referring to FIGS. 26 and 28A-28E, the administrator 104 may also add a new property using the Add a Property link 2018 on the Main Menu page 2000. This page provides an add property entry form 3094 for the administrator to enter information about a property initially. The add property entry form is structured identically to the edit property entry form 2094 and like numbers are numbered alike. Unlike the edit property entry form, the add property entry form does not include pre-filled in information in the text entry boxes, check boxes, or pull down menus. Thus, the first time property data is entered, it must be added by the administrator. Following exemplary information may be entered into the corresponding input box on the entry form. In addition, no thumbnail images will be present in the picture management section 3110 as the database 114 lacks this information when a property is first added. When the property input data is to the satisfaction of the administrator, the Add Property button 3162 may be selected. This adds the property to the Property Queue and indicated in the Property Queue link 2014 on the Navigation menu 2002 (FIG. 23) awaiting approval by the administrator 104.

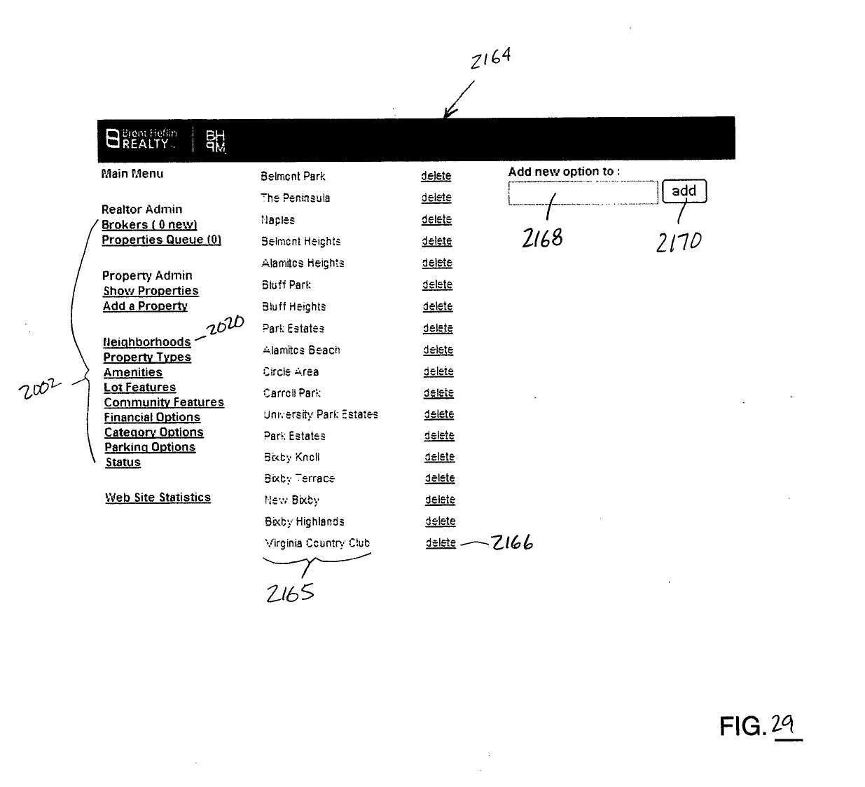

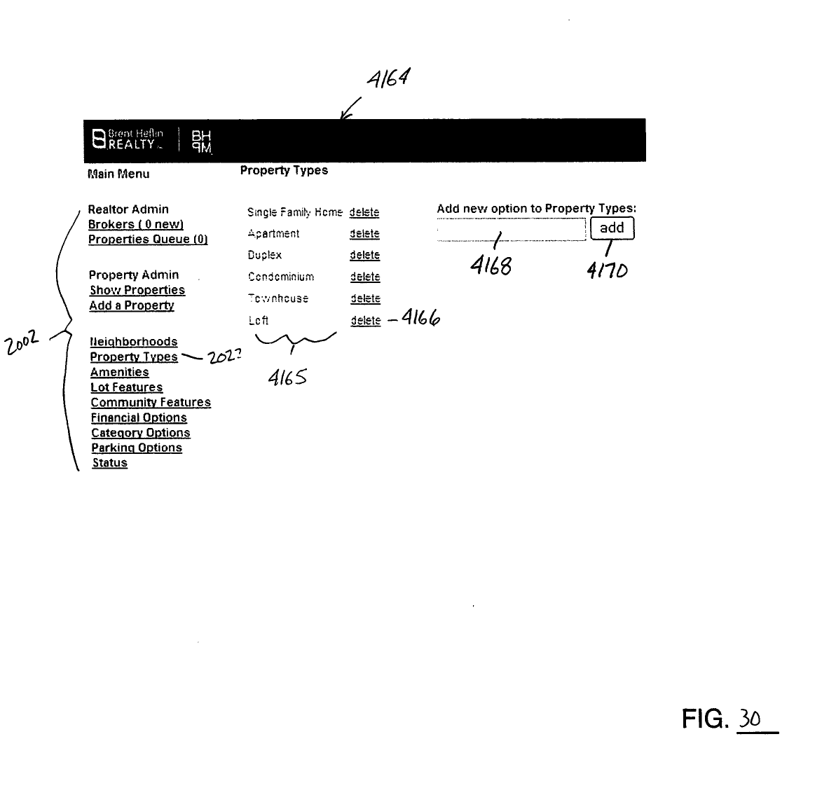

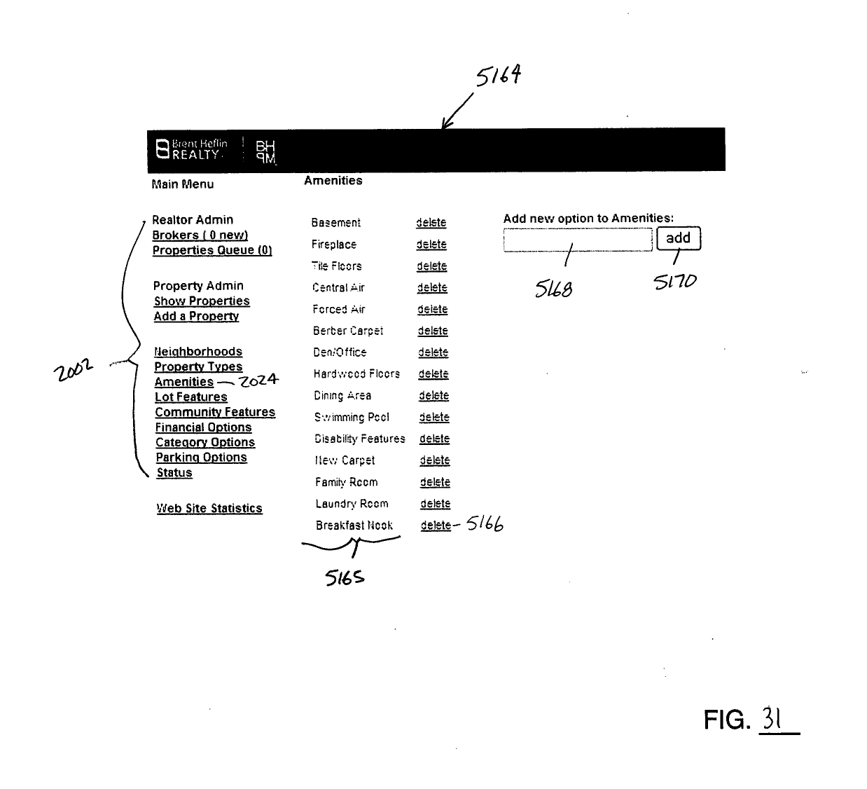

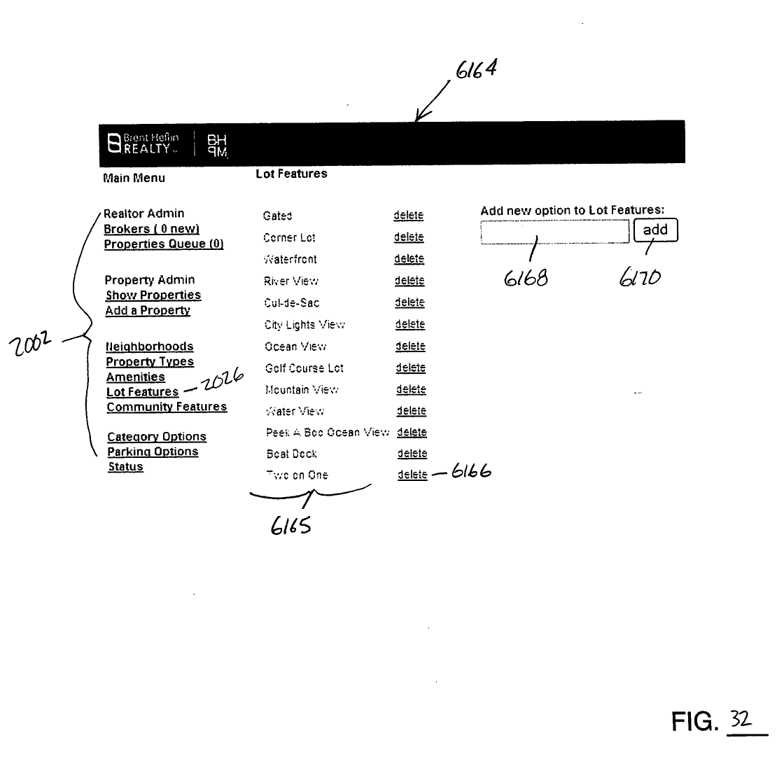

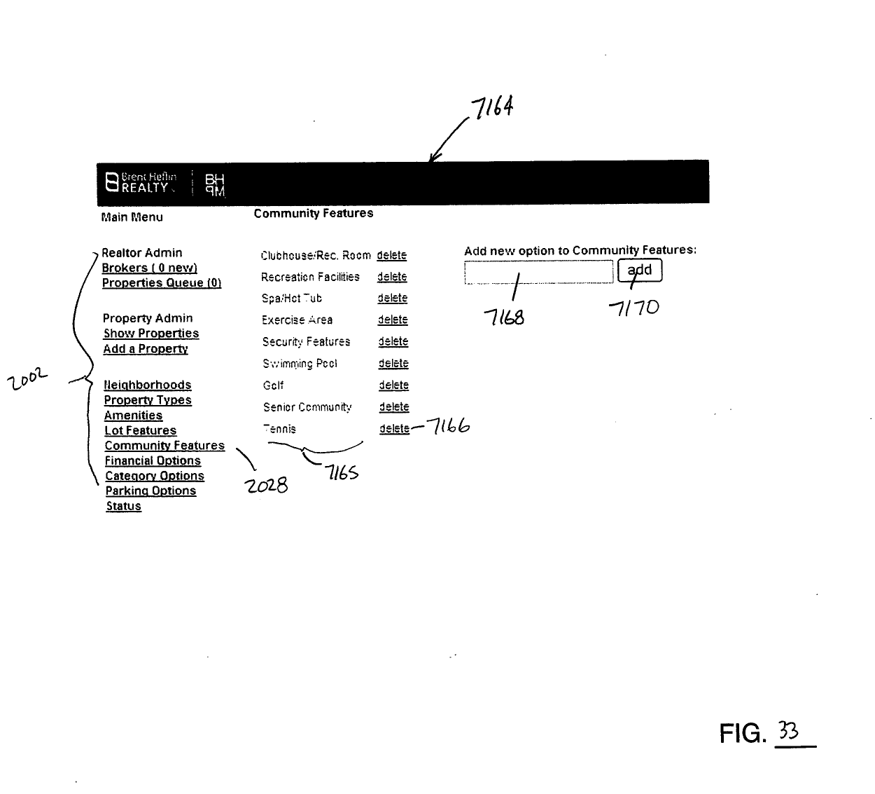

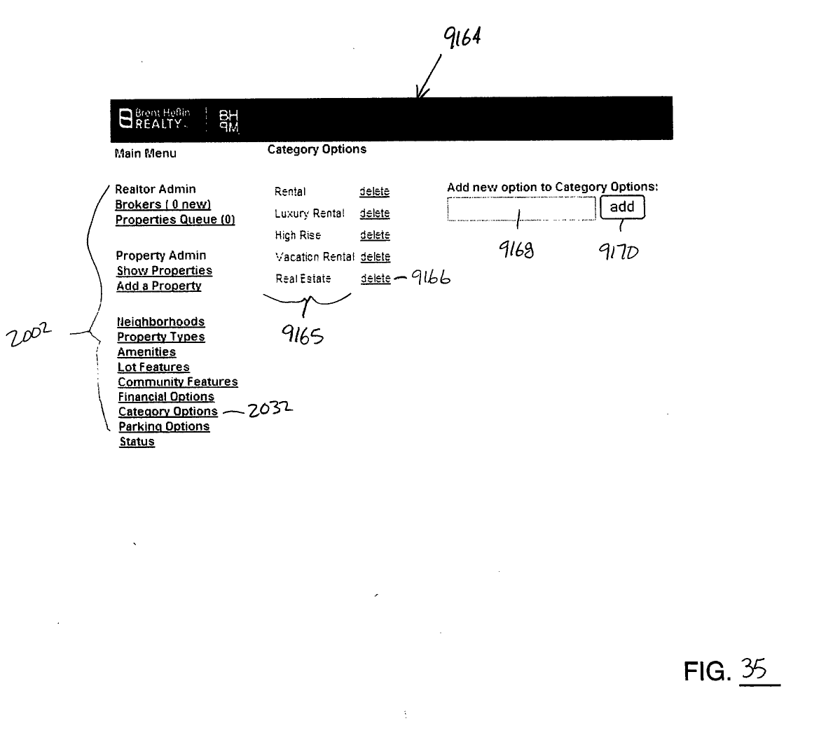

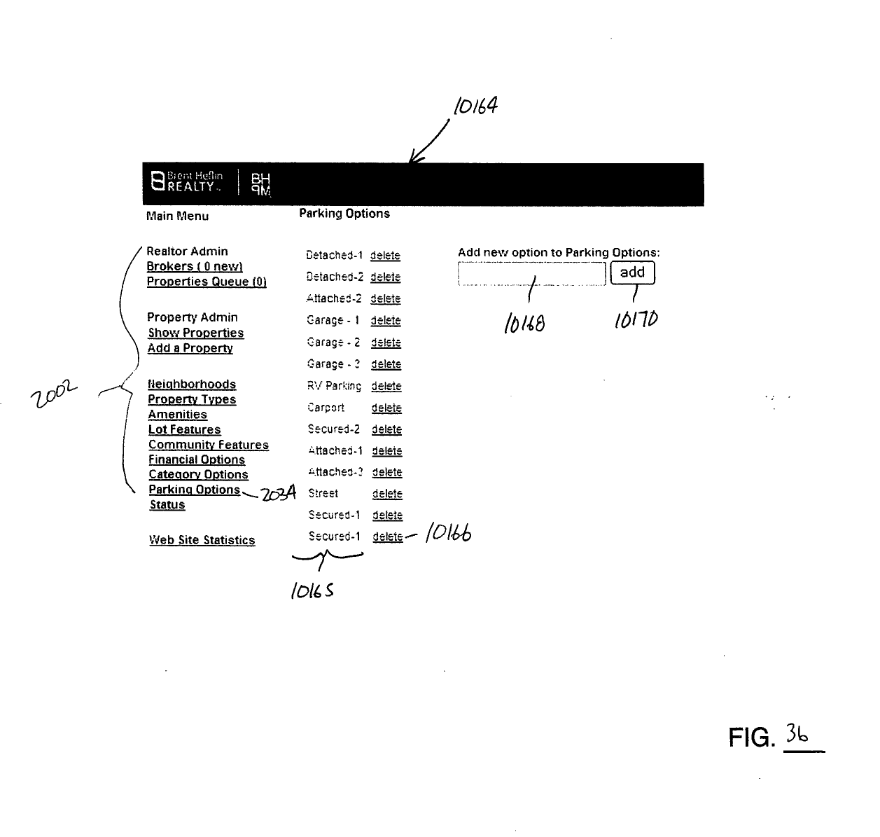

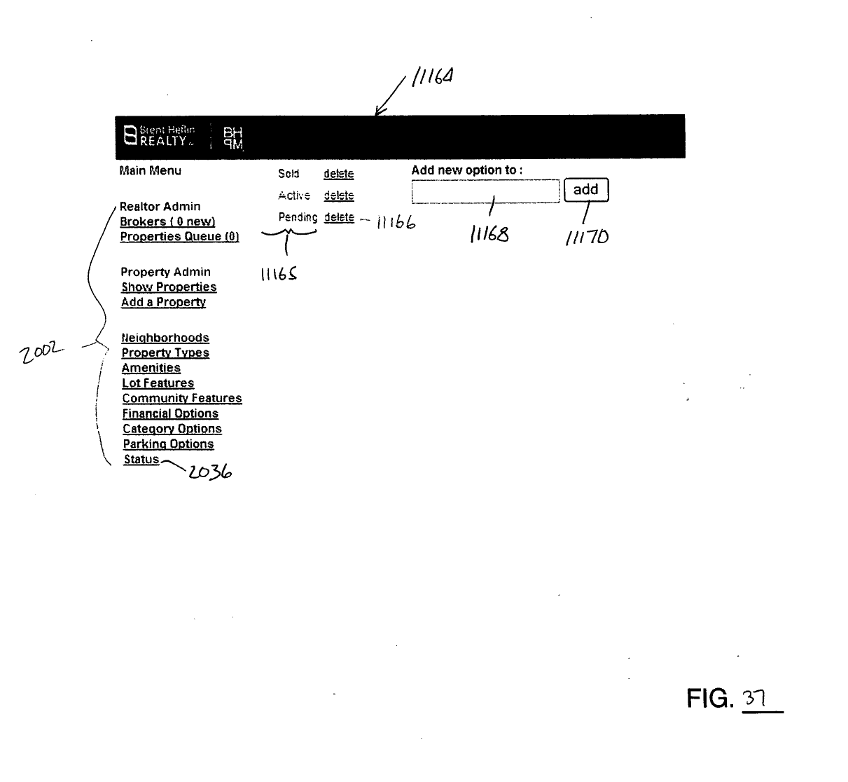

Referring to FIG. 23 and FIGS. 29-37, it will be appreciated that administration of the database 114 may be facilitated through these administration pages. For example, selection of the neighborhoods link 2020 on the Navigation menu 2002 causes the Neighborhoods management page 2164 (FIG. 29). The neighborhoods currently entered into the database 114 are listed in a column format 2165. Next to each neighborhood listing is a delete button as for example, indicated at 2166. Selection of the delete button will remove the corresponding property, in this example, Virginia Country Club, from the database. Then, when an administrator 104 or end user 116 view a property listing, this neighborhood will no longer be available. To add a neighborhood, a neighborhood text entry box 2168 is provided. Selection of the ADD button 2170 next to the neighborhood text entry box will result in the text entered into the neighborhood text entry box to be added to the database 114. This is similar for each management form as illustrated in FIGS. 30-37. There is a property type management page 4164 (FIG. 30) accessible via the property types link 2022 in the Navigation section 2002. There is also an Amenities management page 5164 (FIG. 31) available by selecting the Amenities link 2024. A lot features management page 6164 (FIG. 32) may be accessed by selecting the lot features link 2026. A community features management page 7164 (FIG. 33) is accessible by selecting the community features link 2028. Selection of the financial options link 2030 will cause the financial options management page 8164 to appear on the administrator's monitor 105. The category options management page 9165 (FIG. 35) is available via the category options link 2032. A parking options management page 10164 (FIG. 36) may be displayed upon selecting the parking options link 2034. In FIG. 37, a status management page 11164 is illustrated and is accessible by selecting the status link 2036 on the Navigation menu 2002. Each management form includes a set of descriptors in columnar format spaced apart from a corresponding delete button. A descriptor text entry box and ADD button are also provided for each screen. As these pages (FIGS. 29-37) are laid out and operate in a similar manner, like numbers have been used to represent like management page components. It will be appreciated that by adding and deleting entries into these forms, the property listings may be tailored to suit the administrator's needs.

Exemplary Rental Process

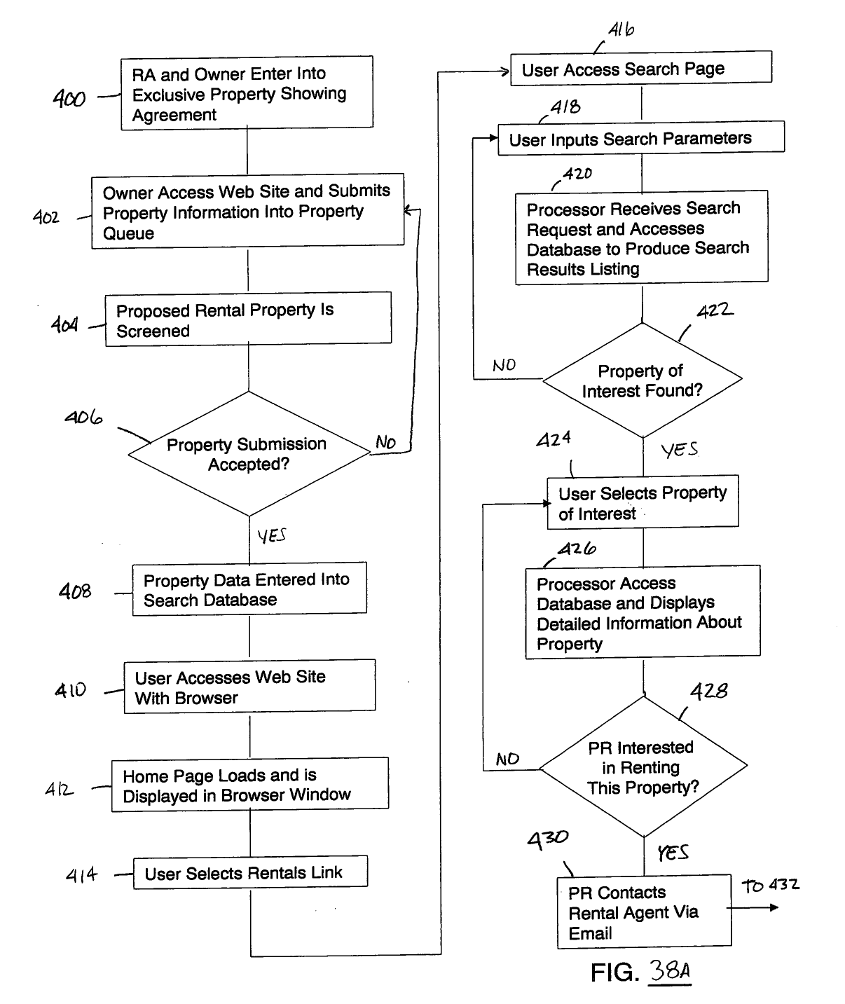

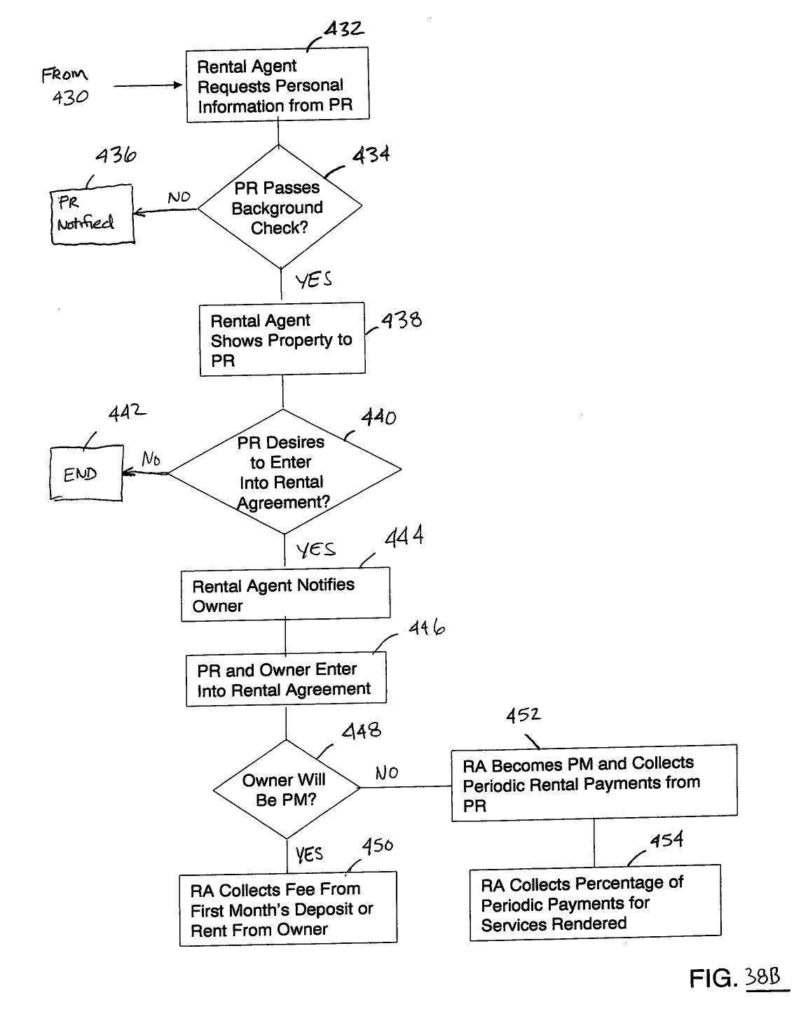

Referring now to FIGS. 1, 38A and 38B, an exemplary process for renting or selling a property will now be explained. While many of the same steps in the process will apply with equal force to either the leasing or selling of residential or commercial real estate, the rental process will include additional management steps and is accordingly described in exemplary detail. In step 400, to start the process, a broker 117 and an owner 119 enter into an exclusive agreement for showing at least one property 113. It will be appreciated that this process may take the place of advertising the property in the local or regional newspaper or placing a sign outside the property as the entire transaction can be run via the website and between the broker, owner, and prospective resident 123. It will also be appreciated that the broker 117 may act in the role of the system administrator 104 and/or data manager 106 and this is assumed throughout this example.

The property owner 119 may access the web site 112 using conventional browsing techniques from a remote end user computer 108. The property owner submits the property information or property details 115 for the proposed property to be rented or sold. This takes place at step 402. To enter the property details 115 into the system for marketing and managing real property, a data manager 106 or the system administrator 104 takes the property details 115 from the property owner 119 and accesses the realtor/broker administration pages using an input device 107. The input device may also be used by the system administrator 104 to add a property (FIGS. 28A-28E) in the add a new property form 3094. The data manager 106 may then enter the available property details 115 into the corresponding input area in general information section 3096, the amenities section 3098, the lot features section 3100, the community features section 3102, the financial options section 3104, description section 3106, and the MLS ID section, 3108 as described above in the realtor administration section.

The broker 117 may appoint the data manager 106 to obtain photographs of the property 113, preferably using a digital camera as an input device 107. The digital photographs are saved on a digital media and stored in the transaction server 102. Referring now to FIG. 28D, a file path name is entered into the picture management section 3110 using an input device 107 such as a keyboard for each picture taken. A file path name for a thumbnail version of the image is entered into thumbnail path slot 3150a and a file path name for an enlarged picture version of the same image is entered into the enlarged image path slot 3152a. If known, a link such as a web address to a virtual tour of the property is added to the tour link section 3154. Assuming for this example that the property is Active and is available, the system administrator 104 selects YES in the Active status box 3156. The privacy setting is also selected by the system administrator at this point to either YES or No. If the property is to be made available on the Featured Properties page 228 (FIG. 14), the system administrator sets the Featured selection box 3160 to YES.

Once the data is entered into the database table 114, the system administrator 104 selects the add property button 3162 (FIG. 28D). This action moves the proposed property into the property queue 2010 (FIG. 23) and the counter 2014 increases by one to indicate a property is in the queue. The proposed property 113 is then screened by the broker 117 at step 404 (shown in the exemplary rental context). In addition to reviewing the property details 115 in the property queue 2010, the broker 117 may interview the owner on site to confirm the property details. This helps to reduce the liability of the owner by confirming the property details 115 including any photographs represent an accurate portrayal of the property 113. Information such as prior water or smoke damage, mold problems, and other environmental factors or pre-existing conditions that may effect a prospective resident's decision to rent or buy the property may be investigated and noted in the property details 115.

With continued reference to FIG. 38A, at step 406, the broker (in a system administrator role) may accept the property in the property queue 2010 by logging into the realtor administration page 2000 (FIG. 23) and selecting an approve button 2046 in the row corresponding to the property in the property listing table 2038 representing the property or properties in the property queue 2010. If the property is not accepted, the property owner may enter another property by going back to step 402. Once the system administrator approves the property details 115, a YES indicator will be displayed beneath the Approved column 2082 in the property listing table 2088 (FIG. 26). This may take place at step 408. The property details 115 are now available to be searched using the web site 114 search engine such as via the simple search page 1028 (FIGS. 10A, 10B) or advanced search page 1050 (FIGS. 15A, 15B).

With reference to FIGS. 1 and 7, a prospective resident 123 (“PR”) seeking to rent or purchase a property may then access the home page 1000 by typing or otherwise entering a web address using a conventional browser from the end user computer 108 (step 410). On the end user's display device 109, the home page will load and be displayed (step 412). If prospective resident desires to lease a property, he or she acting as a prospective renter may select the Leasing and Rentals category block 1004 to expand a list of available links including the rentals link 1018 (FIG. 8). The PR then selects the rentals link at step 414 to bring up the rentals page 1020 (FIG. 9) and a start search button 1026. The PR may then access the simple search page 1028 (FIGS. 10A, 10B) by selecting the start search button (step 416). The simple search page will load into the PR's browser and display on his or her monitor 109. The PR may then enter search criteria into the text input and pull down boxes on the simple search page 1028. Simple search information may include search criteria such as category of rental, city, state, zip code, neighborhood, price range, number of beds, and number of baths. Once the desired search criteria have been entered by the PR 123, the PR selects the search properties button 202 (Step 418). While a PR who is a prospective purchaser of a property will often times prefer to be contacted by a broker for personalized attention, it is further contemplated that the processes described above in the rental context may also be made available for prospective purchasers after selection of the Real Estate category block 1008 (FIG. 8) from the home page 1000 to expand a list of available links including a buyer's link, a seller's link, a featured properties link, a search ftmction link and a link to agents/brokers. The same processes and functions may also be made available to prospective purchasers or renters of commercial properties after selection of the Commercial Property category block 1010 (FIG. 8) from the home page 1000.

With continued reference to the exemplary rental process of FIG. 1, 10A, and also of FIG. 11, selection of the search properties button 202 at the end user computer 108 transmits a search signal over the network 110 to the transaction server 102. This search signal along with the search criteria are received by the transaction server. The transaction server then accesses the property tables 126 in the database 114 and retrieves all Active properties 113 in the database that have property details 115 matching the search criteria input into the simple search page 1028 by the PR and a search results listing is transmitted back to the PR's computer 108 for display on the display device 109 (step 420). Referring to FIG. 11, the property results listing 201 displays all property listings 1032a, 1032b, and 1032c matching the search criteria. If no property of interest is located by the PR 123 by reviewing the thumbnail photograph 1034a and general details 1036a, 1038a for each result listing, then the PR may go back to step 418 and enter a new set of search criteria in the simple search page.

Assuming a property of interest is found, the PR may select the details link 204 of the property listing of interest to request a property details page (step 424). Selection of the details link 204 transmits a request to the transaction server 102 for a property details page 206 (FIG. 12). The transaction server retrieves the additional property details, if available, from the property tables 126 in the database 114 and transmits back to the PR computer 108, a property details page 206 for display on the PR's monitor 109 (step 426). The property details 115 entered by the system administrator 104 or data manager 106 using the realtor administration module and add a property pages (FIGS. 28A-28D) may be viewed in the corresponding sections on the property details page 206. For example, an enlarged image of the property is displayed in the enlarged picture section 210 with remaining thumbnail images displayed in the remainder of the picture section 212. General information such as property category, property type, neighborhood, year built, parking situation, lot size, and status are displayed in the general information section 214. In the lot features section 218, amenities section 220, and community features section 222, boxes are checked next to the corresponding categories matching the property details 115 entered into the database 114. If, after reviewing the property details page 206, the PR is not interested in the property 113, he or she may return to the property listing results page 201 at step 424 and select another property.

Assuming the PR is a prospective renter interested in renting the property shown on the property details page 206, the PR may select the Contact link 1040 (step 430). Selection of this link by the PR transmits a signal across the network 110 to the transaction server 102 to return an email contact form 1042 (FIG. 13). The email contact form is automatically filled in with the broker's email address to save the PR entry time in addition to a property identifier 1046 in the subject line. The PR may contact the broker by typing a message in the text entry box 1048 and selecting the send button 1043. The email message is transmitted over the network to an email box in the transaction server 102 or other suitable email box matching the email address in the address line 1044.

Referring now to the flow chart in FIG. 38B, the broker may respond to the PR's request by contacting the PR via telephone, return email, or other suitable communication mode. In a rental scenario, the broker then begins a screening process of the PR by requesting personal information from the PR (step 432). A form generated by the transaction server 102 may be used and submitted over the network 110 to the PR's computer 108. At this point, prior to showing the PR the property in person, the PR is screened (step 434) to reduce the likelihood of injury to the rental agent broker when showing the property and also to reduce the liability of the PR and owner by verifying the history and payment credentials of the PR. Preferably, the screening procedure is in depth and may include a review of information such as the PR's criminal history, including a sex offender database review, payment history, credit history, employment history, past tenancy information including complaints filed, personal identification verification and references. A suitable screening service is available from the Brent Heflin Realty, Inc. of Long Beach, Calif. under the service mark Veri-rent^{SM} or Vali-rent^{SM}. The PR may be charged a fee for this process. Alternatively, the fee may be charged to the property owner 119. Each of the adults that will be renting are screened. If the prospective resident 123 is a prospective purchaser looking to purchase a property in the community, then this screening may involve inquiry into relevant purchaser information such as the prospective purchaser's method of financing to include mortgage qualification and general credit worthiness and willingness to pay for the closing costs and other related transactional costs, which may then be assessed for compliance with criteria dictated by the owner 119.

If the PR does not pass the background check, the process is terminated and the PR is notified (step 436). Assuming the PR passes the background check at step 434, the broker sets up a time to show the property and the PR and broker walkthrough the property at the designated time (step 438). Preferably, the broker accompanies the PR at all times to answer any questions the PR may have. After viewing the property, the PR must decide whether or not to rent or purchase the property (step 440). If the property does not interest the PR, the process is terminated (step 442) or another property may be shown to the PR. Assuming that the PR desires to enter, for example, into a rental agreement, the broker 117 notifies the property owner 119 (step 444). A rental agreement is then drawn up and the PR and owner enter into the agreement (step 446). As part of the agreement, the owner may decide whether or not to also act in the role of property manager including the task of collecting rents (step 448). Should the property owner desire to also be a property manager, then the broker enters into an agreement to collect a portion of the first month's rent collected from the PR from the property owner to pay from the services rendered including interviewing the PR, conducting the background check, and showing the property (step 450). Should the property owner not wish to act provide the role of property manager, the broker may step into the role and provide those services as well. In that case, the broker may collect the periodic monthly payments from the former PR, now a renter (step 452). As part of the agreement between the owner and the broker, the broker collects a percentage of each periodic rental payment from the renter to pay for services rendered including the initial PR background check and property showing (step 454). It will be appreciated that the role of property manager may be determined in the initial agreement entered into between the property owner 119 and the broker 117 back at step 400. To this end, the various property management functions the broker wishes to make available to property owners may be displayed for owners seeking such services after selection of the Property Management category block 1006 (FIG. 8) from the home page 1000 to expand a list of available property management services by links or for displaying a narrative detailing these services.

It will be appreciated that the initial costs of the search process are not applied to the PR until a property of interest has been selected and the PR enters the screening process. As the owner can generally bear the costs better than the PR, it is preferable to avoid charging a fee to the PR for just searching the property listings. No paper lists are provided as these are easily outdated. Only Active listings are available via a search. As both the owner's property details and background of the PR are investigated, liability to either party is reduced significantly.

It will further be appreciated that this exemplary rental process was described using simple search entry form as in FIGS. 10A, 10B. However, the PR may select the advanced search link 1030 to bring up the advanced search page 1050 (FIGS. 15A. 15B) and conduct a more detailed and narrower property search using the available search criteria on that page 1050.

Relocation Assistance

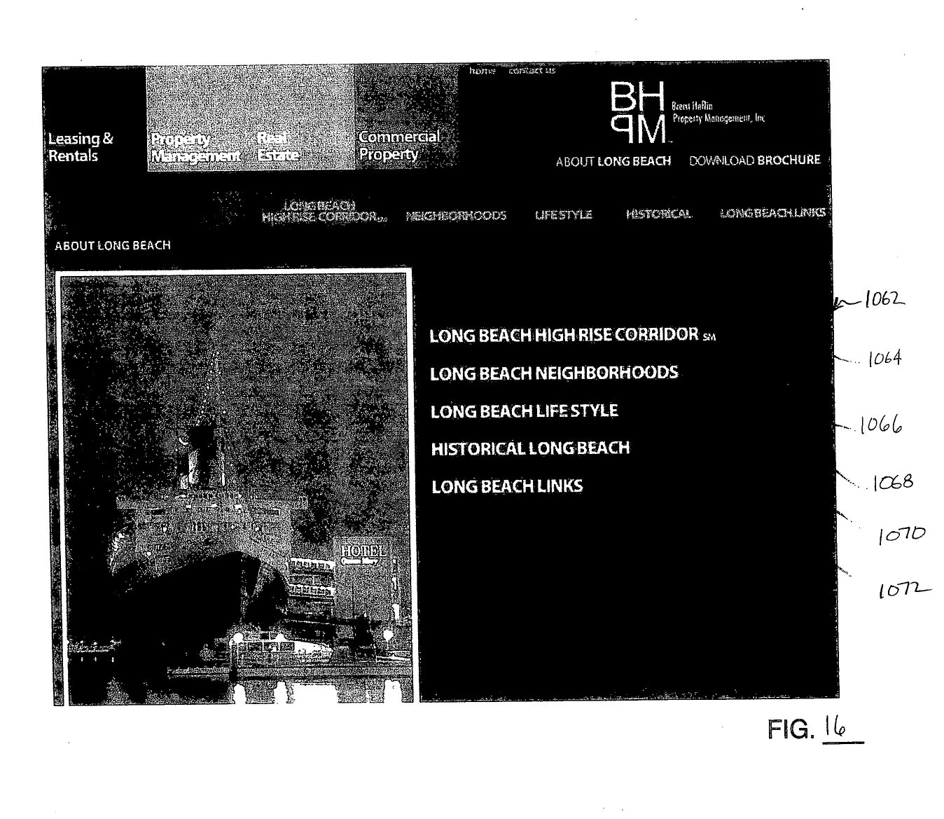

It will be appreciated that the system and method of marketing and managing real property 100 described herein is preferably focused on a local community to provide the detail missing from national databases or databases maintained from remote locations by individuals unfamiliar with the local community. This present invention seeks to provide detailed information as to the community including local culture, local history, local neighborhoods, and local links to local business, local entertainment, and other local interests to provide a real flavor of the community to a prospective resident, particularly those seeking to relocate to the community and unfamiliar with the local area. For example, in addition to searching for property listings as described above, the PR may access the home page 1000 (FIG. 7) and then select the local area link 1014. Selection of the local area link 1014 will cause the local information main page 1062 (FIG. 16) to display on the PR's monitor 109. The PR may also arrive directly at this local information web-page by linking from search engine results or by links from other web sites. The PR may then access a variety of local community information pages including any of the local grouped property pages 1074 (FIG. 17), local neighborhoods page 1086 (FIG. 19), local lifestyle page 1090 (FIG. 20), local history page 1094 (FIG. 21), or local links page 1096 (FIG. 22) by selecting the corresponding link 1064, 1066, 1068, 1070, or 1072, respectively, on the local information main page 1062. By reviewing these pages, the PR may learn a significant amount of detail about the community in which he or she may want to reside thus saving time and money by narrowing down viable communities prior to incurring the travel expenses of an in person tour. Also, the PR is provided with links to the above described categories and searchable property information from these local information pages so that he or she can search the available properties in the community, or take advantage of any of the above described property management capabilities, if desired.

In this regard, it is contemplated that the present system and method 100 may also be used after an agreement or relationship is established with given entities to assist in providing relocation assistance to their existing or potentially new members, employees and the like, who often share common rental criteria. Entities that may benefit from such services include governmental agencies, health care providers, medical groups, organizations, associations, partnerships, firms, leagues and corporations. Once these common rental criteria for a given entity have been established, then a specific relationship page may be set up that is specifically tailored to the needs of its members or employees. In such instances, the home page 1000, the local area link 1014, the local information main page 1062, or any other appropriate or desired page is designed to include a link which will connect the employee or member to the selected relationship page.

These relationship pages may then be set up to include accessible information on properties in the database 114 that satisfy the common rental criteria of its members, along with any of the above described functions or informational links that are deemed appropriate. Access to these relationship pages may also be controlled by providing an access code, password or the like which the entity's members or employees must input before being permitted to enter the partnership page. For example, if a professional organization represents doctors, its members seeking to relocate to a given community often share generally similar rental criteria, which may include such things as a targeted property price range, proximity to the local hospital or preferred recreational and cultural activities. The entity's relationship page may then be set up to include a listing of properties which satisfy the organization's common rental criteria, along with information pertaining to or links that provide access to such items as transition services offered by the organization, local neighborhoods and schools, the local hospital's web-site, local and state medical associations, etc.

While the exemplary web site described herein is an English language web site, to further aid in assisting PR's seeking relocation, a link or pull down menu may be provided on the home page 1000, for example, to a matching set of web pages translated into another language, such as Mandarin Chinese, Spanish, French, German, Japanese, or any other language suitable for web site displays. Thus, a non-English speaking PR may select a translated page pull down menu 1001 on the home page to convert the English language site into another language. By selecting the translation pull down menu, a listing of available languages may be accessed. The PR may scroll down to the desired language and let go of the mouse button of the input device 111 of the PR's computer 108. Selection of an alternative language transmits a signal to the transaction server 102. The transaction server may access the corresponding alternative language web site stored in the server or other suitable storage media and transmit the translated web pages to the PR as the PR peruses the web site 114.

Site Replication

As described above, the database 114 is preferably tailored to store property information about a community or specific geographic region so that significantly more detail about the community may be displayed on the web site 112. It will be appreciated that the database may be tailored with information from other communities. For example, a realtor or rental agent in another community may want to display properties in a community other than Long Beach as the example described herein.

With reference to FIGS. 1, 4, 39-40, the site replication function 186 (FIG. 4) governs the registration of brokers, realtors, leasing agents or other property listing, leasing or selling representatives (“brokers”) 117 for approval to create their own site tailored to their own community. A broker 117 at a remote terminal 108 may access the web site 114 as above and select a registration link (not shown) on the home page 1000 to bring up a broker login page 300. On the this page, the broker 117 may register if a first time user by selecting a listing registration link 302. Alternatively, the broker may login by filling in a login entry form 304 with email slot 306 and password slot 308, if already registered. If the registration link 302 is selected, a sign up page 310 provides contact information in the contact information section 312, password selection in the password section 314, and the broker may select to receive a newsletter in the newsletter pull down menu 316. The exemplary sign up page 310 includes the following fields to be filled in by the realtor: Last Name, Company Name, Address1, Address2, City, State, Zip, e-mail address, Website, Business phone, Cell Phone, Fax, Username, Password, Password Question, Password Hint, Site Name, and Newsletter.

Once the information is entered, the broker selects the continue button 318. Selection of the continue button transmits the information entered into the registration form to the transaction server 102. The information is placed in the broker queue as represented at 2008 (FIG. 23). A system administrator may then access the realtor administration site and review the broker contact information 2044 (FIG. 24) in the broker's queue 2008. If the broker is approved by the system administrator selecting the approve button 2046, once registered, an auto response email will be sent to the email address input by the broker confirming registration. Then that broker may be granted access to a replicated version of the web site 114 through the site replication function 186 (FIG. 4) including the database tables 114 and the database modification pages as in FIGS. 28A-37 for adding properties and modifying the property details 115 and search criteria.

This arrangement may involve a licensing agreement between the system administrator 104 and the prospective broker 117 seeking a replicated web site 114. As the web site format is pre-built and modifiable, other broker may save time building their own realty web site and database by requesting the replication option. Then, the database may be tailored with local information and local property details for the area in which the broker 117 is most familiar.

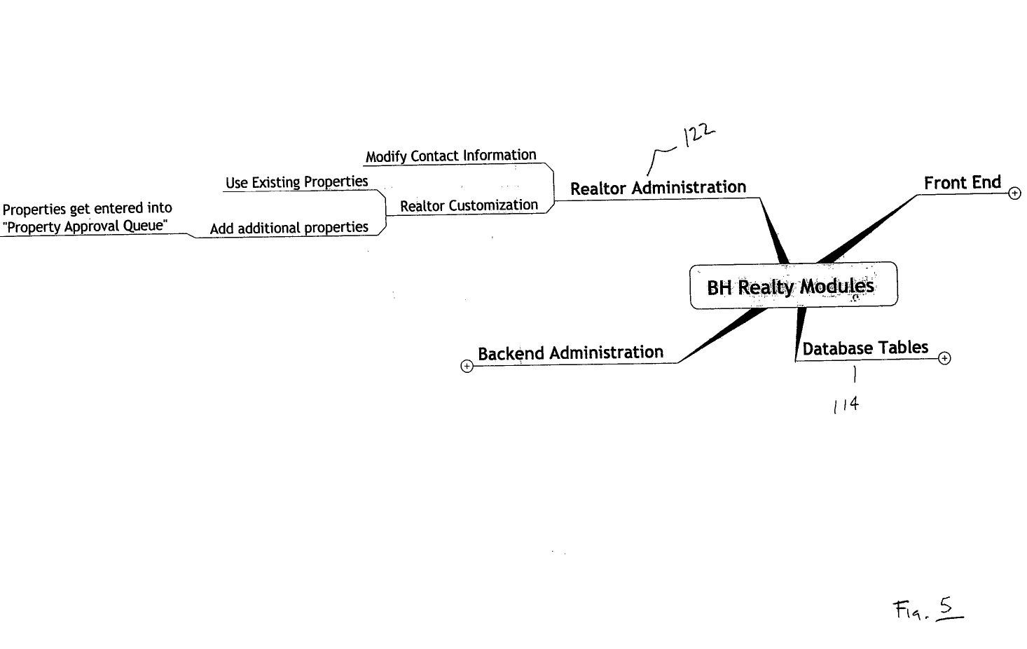

Once the broker information is stored in the database, the Realtor Administration module 122 (FIG. 5) provides the capability of modifying the contact information, as well as loading properties into a property queue to be accepted or rejected by the system administrator 104. Broker customization includes enabling use of existing properties or adding properties into the Realty Database by submitting a property into the property queue as described above. Properties entered by the broker may be limited in access to that broker.

The search criteria and property details described herein are exemplary and are not meant to be limiting. While a global network 110 such as the internet is preferred for communicating between the transaction server 102 and the end user computer 109, a LAN or WAN or other suitable network may be used as well. The end user computer may also be set up in close proximity with the transaction server such as in a broker's office and need not be remote. In addition, it will be appreciated that the present invention removes the necessity of printed media advertising as the entire brochure or flyer relating to a property is available on line. This may also remove the need for unattractive signage on the front of property. The flexibility of modifying the database 114 also facilitates tailoring the database to fit a variety of property owner needs.

The example described herein is has been primarily focused in terms of a rental property search and related transactions. However, as addressed above, the present invention may be applied to property management and marketing for the purchase and sale of real estate, and may be used to conduct transactions between buyers and sellers of residential or commercial real estate as well. Moreover, while the above described embodiments have generally focused on the exemplary aspects of residential property listings and information, the present invention also encompasses commercial properties.

While the present invention has been described herein in terms of a number of preferred embodiments, it will be appreciated that various changes and improvements may also be made to the invention without departing from the scope and spirit thereof. Accordingly, it is not intended that the invention be limited except by the appended claims.

What is Claimed is:

1. A method for marketing and managing real property for a property owner comprising:
entering into an agreement with a property owner to advertise a property for rent;
receiving a set of property related information from said property owner, said property related information including a location parameter, a price parameter, and an amenities listing;
entering said parameters and said amenities listing in a database;
providing a processing unit with access to said database;
providing a display interface in communication with said processing unit;
upon request from a prospective renter, displaying said property related information in a viewable format on a remote display device;
obtaining a set of personal information about said prospective renter;
based on said set of personal information, prescreening said prospective renter prior to showing said property;
upon approval of said prospective renter, showing said property located at said location parameter;
upon a rental agreement being established between said prospective renter and said property owner, establishing a fee arrangement with said owner; and
collecting said fee.

2. The method as set forth in claim 1 wherein:
said fee arrangement includes receiving a portion of a first month's rent.

3. The method as set forth in claim 1 wherein:
said fee arrangement includes receiving a portion of a monthly rental income on a periodic basis.

4. The method as set forth in claim 1 further including:
collecting a periodic rent payment from said prospective renter;
and deducting a portion of said rent payment as payment for advertising said property related information on said remote display device.

5. The method as set forth in claim 1 wherein:
said agreement with said property owner is exclusive.

6. The method as set forth in claim 1 wherein:
said property is selected from a group consisting of a home, a condominium, a townhouse, an apartment, a vacation rental, a luxury rental, a lot, a building, a commercial property and a region of land.

7. The method as set forth in claim 1 further including:
viewing said property in person to determine whether any pre-existing conditions exist that would prevent a rental agreement from being reached.

8. The method as set forth in claim 1 wherein:
said prescreening step involves checking employment records, employment references, bank credit, past leasing experience, personal references, sex offender databases, and criminal history of said prospective renter.

9. The method as set forth in claim 1 further including:
displaying a search page in response to an inquiry from said prospective renter;
receiving a set of search parameters from said prospective renter; and
displaying said search results on said remote display device.

10. The method as set forth in claim 1 further including:
upon request from said prospective renter, displaying at least one display page including historical content about an area in which said property is located.

11. The method as set forth in claim 1 further including:
upon request from said prospective renter, displaying at least one display page including lifestyle content about the area in which said property is located.

12. The method as set forth in claim 1 further including:
upon request from said prospective renter, displaying at least one display page including local interest links relating to the area in which said property is located.

13. The method as set forth in claim 1 wherein:
said property related information includes a square footage parameter, a number of beds parameter, a number of floors parameter, a property age parameter, a number of baths parameter, a parking situation parameter, rental type parameter, lot features listing, and a community features listing.

14. The method as set forth in claim 13 wherein:
said parking situation parameter is selected from a group consisting of detached one vehicle, detached two vehicle, attached one vehicle, attached two vehicle, one vehicle garage, two vehicle garage, three vehicle garage, RV parking, carport, secured one vehicle, secured two vehicle, and street.

15. The method as set forth in claim 13 wherein:
said rental type parameter is selected from a group consisting of single family home, apartment, loft, duplex, condominium, and townhouse.

16. The method as set forth in claim 1 wherein:
said amenities listing is selected from a group consisting of basement, central air, den/office, swimming pool, fireplace, forced air, hardwood floors, disability features, tile floors, berber carpet, dining area, new carpet, family room, ocean view, gourmet kitchen, formal dining room, master bedroom, laundry hookups, oven, hot tub, double oven, laundry room, balcony, refrigerator, plantation shutters, community laundry, washer/dryer, convention oven, laundry chute, laundry area, breakfast nook, kitchen nook, granite counters, ceiling fans, dishwasher, microwave, range top, marble flooring, and mock fireplace.

17. The method as set forth in claim 13 wherein:
said lot features listing is selected from a group consisting of lot size, gated, river view, ocean view, water view, corner lot, cul-de-sac, golf course lot, peek a boo ocean view, waterfront, city lights view, mountain view, and boat dock.

18. The method as set forth in claim 13 wherein:
said community features listing is selected from a group consisting of clubhouse/rec. room, exercise area, golf, recreation facilities, security features, senior community, spa/hot tub, swimming pool, and tennis.

19. The method as set forth in claim 13 wherein:
said rental type parameter is selected from a group consisting of rental, vacation rental, commercial, real estate, and luxury rental.

20. The method as set forth in claim 1 further including:
obtaining a digital image of said property at said location parameter;
storing said digital image in said database; and
displaying said digital image along with said property related information on said remote display device.

21. The method as set forth in claim 1 further including:
collecting a fee from said prospective renter prior to conducting said prescreening step.

22. A method for marketing and managing real property for a property owner comprising:
storing a set of property details associated with a property in a database;
providing a processing unit with access to said database;
upon request from a prospective renter to said processing unit, transmitting said property details in a viewable format for viewing on a remote display device;
prescreening said prospective renter prior to showing said property based on a set of personal information supplied by said prospective renter;
establishing a fee arrangement with said owner of said property upon a rental agreement being established between said prospective renter and said property owner; and
collecting said fee.

23. In a web site on a global communication network, a series of web pages upon which rental agency transactions may be conducted, said web site comprising:
a first page having a rental section, said rental section including a search page link, said first page further including a local culture link;
a search page selectively operable to display on a display device upon selection of said search page link, said search page providing a search entry form operable to receive a set of search parameters from a user, said search parameters including a type of rental parameter and a price parameter;
a local culture page selectively operable to display on a display device upon selection of said local culture link, said local culture page including a description of a local lifestyle and a local history for a predetermined geographic area;
a search results page operable to display a listing of at least one property matching said search parameters, said listing including at least one photograph of a corresponding property, an address of said property, an offer price, and an amenities listing; and
said search results listing including a contact link operable to display an email form having a send button, an address input box, a subject line, and a comments input box for inputting a message to a rental agent, said address input box having a pre-filled address of said rental agent, said subject line including a predetermined property ID corresponding with said property selected from said results listing whereby a user may input a comment in said comments input box and select said send button to transmit said email form to said rental agent at said pre-filled address.

24. A method for marketing and managing a piece of real property for a property owner comprising:
entering into an agreement with a property owner to advertise a property for rent;
receiving a set of property related information from said property owner, said property related information including a location parameter and a price parameter;
entering said set of property related information in a database;
providing a processing unit with access to said database;
providing a display interface in communication with said processing unit;
upon request from a prospective renter, displaying said property related information in a viewable format on a remote display device;
obtaining a set of personal information about said prospective renter;
comparing said set of personal information with selected prescreening information;
based on said comparing and upon approval of said prospective renter, showing said property located at said location parameter;
upon a rental agreement being established between said prospective renter and said property owner, establishing a fee arrangement with said owner; and
collecting said fee.

25. The method of claim 24 further including:
compiling a set of local information about the local community and surrounding geographic area in which said property is located;
providing said prospective renter with selectable access to said local information;
in response to an exercise of said selectable access by said prospective renter, transmitting said local information in a viewable format to said remote display device.

26. The method of claim 25 further including:
providing said prospective renter with selectable access to said local information while displaying said property related information.

27. A method for marketing and managing real property comprising:
entering into an agreement with multiple property owners to advertise properties for rent;
receiving sets of property related information from said property owners, said property related information including a location parameter, a price parameter, and an amenities listing;
entering said parameters and said amenities listing in a database;
providing a processing unit with access to said database;
providing a display interface in communication with said processing unit;
compiling a set of local information about the community and surrounding geographic area in which said properties are located;
upon request from a prospective renter, displaying said local information in a viewable format on a remote display device;
providing said prospective renter with selectable access to said property related information while said renter is viewing said local information;
in response to an exercise of said selectable access by said prospective renter, transmitting said property related information in a viewable format to said remote display device;
obtaining a set of personal information about said prospective renter;
based on said set of personal information, prescreening said prospective renter prior to showing a selected property selected from said properties;
upon approval of said prospective renter, showing said selected property located at said location parameter;
upon a rental agreement being established between said prospective renter and the owner of said selected property, establishing a fee arrangement with said owner; and
collecting said fee.

28. The method of marketing and managing real property of claim 25, wherein:
said local information includes historical information about said community and surrounding geographic area.

29. The method of marketing and managing real property of claim 25, wherein:
said local information includes information about local neighborhoods in said community and surrounding geographic area.

30. The method of marketing and managing real property of claim 25, wherein:
said local information includes information about local culture, entertainment and activities pertinent to said community and surrounding geographic area.

31. The method of marketing and managing real property of claim 25, wherein:
said local information includes information about business and government entities and services pertinent to said community and surrounding geographic area.

32. A method for marketing and managing real property for property owners comprising:
entering into an agreement with said property owners to advertise properties available for rental in a specific community and surrounding geographic region;
receiving a set of property related information from said property owners for each of said properties, said property related information including a location parameter, a price parameter, and an amenities listing;
entering said properties and said property related information in a database;
providing a processing unit with access to said database;
providing a display interface in communication with said processing unit;
establishing a relationship with a selected entity for providing relocation services to members of said entity;
compiling a set of common rental criteria for said members;
upon request from one of said members, displaying in a viewable format on a remote display device said property related information for said properties that satisfy said common rental criteria;
obtaining a set of personal information about one of said members and a listing of selected properties satisfying said common rental criteria;
based on said set of personal information, prescreening said one of said members prior to showing any of said selected properties;
upon approval of said one of said members, showing at least one of said selected properties to said one of said members;
upon a rental agreement being established between said one of said members and one of said property owners for renting one of said selected properties, establishing a fee arrangement with said one of said property owners; and
collecting said fee.

33. The method of marketing and managing real property of claim 30, further comprising:
requiring said one of said members to correctly input specifically identified access information before displaying said property related information for said properties that satisfy said common rental criteria.

34. The method of marketing and managing real property of claim 30, wherein:
said entity is selected from a group consisting of governmental agencies, health care providers, medical groups, organizations, associations, partnerships, firms, leagues and corporations.

35. A method for marketing and managing a piece of real property, comprising:
entering into an agreement with a property owner to advertise an interest in a property;
receiving a set of property related information from said property owner, said property related information including a location parameter and a price parameter;
entering said set of property related information in a database;
providing a processing unit with access to said database;
providing a display interface in communication with said processing unit;
upon request from a prospective resident of said property, displaying said property related information in a viewable format on a remote display device;
obtaining a set of prospective resident information about said prospective resident;
screening said set of prospective resident information to ensure compliance with selected prescreening criteria;
based on said screening and upon approval of said prospective resident, showing said property;
upon an agreement being established between said prospective resident and said property owner for said sale of an interest in said property, establishing a fee arrangement with one of said property owner or said prospective resident; and
collecting said fee.

36. The method of claim 35, wherein:
said sale of an interest in said property is for the rental of said property.

37. The method of claim 35, wherein
said sale of an interest in said property is for the purchase of said property.

38. A method for marketing and managing a piece of real property for a property owner comprising:
entering into an agreement with said property owner to advertise the sale of an interest in a property;
receiving a set of property related information from said property owner, said property related information including a location parameter and a price parameter;
entering said set of property related information in a database;
providing a processing unit with access to said database;
providing a display interface in communication with said processing unit;
upon request from a prospective purchaser, displaying said property related information in a viewable format on a remote display device;
obtaining a set of purchaser information about said prospective purchaser;
comparing said set of purchaser information with selected prescreening criteria;
based on said comparing and upon approval of said prospective purchaser, showing said property located at said location parameter;
upon an agreement being established between said prospective purchaser and said property owner for said sale of an interest in said property, establishing a fee arrangement with one of said owner or said purchaser; and
collecting said fee.

39. The method of claim 38, further comprising:
compiling a set of local information about the local community and surrounding geographic area in which said property is located;
providing said prospective purchaser with selectable access to said local information; and
in response to an exercise of said selectable access by said prospective purchaser, transmitting said local information in a viewable format to said remote display device.

40. The method of claim 39, further comprising:
providing said prospective purchaser with selectable access to said local information while displaying said property related information.

41. A method for marketing and managing real property comprising:
entering into an agreement with multiple property owners to advertise the sale of an interest in respective properties;
receiving sets of property related information from said property owners, said property related information including a location parameter, a price parameter, and an amenities listing;
entering said property related information in a database;
providing a processing unit with access to said database;
providing a display interface in communication with said processing unit;
compiling a set of local information about the community and surrounding geographic area in which said properties are located;
upon request from a prospective purchaser, displaying said local information in a viewable format on a remote display device;
providing said prospective purchaser with selectable access to said property related information while said prospective purchaser is viewing said local information;
in response to an exercise of said selectable access by said prospective purchaser, transmitting said property related information in a viewable format to said remote display device;
obtaining a set of purchaser information about said prospective purchaser;
based on said set of purchaser information, prescreening said prospective purchaser;
upon request from said prospective purchaser to see a selected property selected from said properties and approval of the respective said owner of said selected property based on said prescreening, showing said selected property to said prospective purchaser;
upon a purchase agreement being established between said prospective purchaser and said owner, establishing a fee arrangement with one of said purchaser or said owner; and
collecting said fee.

42. The method of marketing and managing real property of claim 41, wherein:
said local information includes historical information about said community and surrounding geographic area.

43. The method of marketing and managing real property of claim 41, wherein:
said local information includes information about local neighborhoods in said community and surrounding geographic area.

44. The method of marketing and managing real property of claim 41, wherein:
said local information includes information about local culture, entertainment and activities pertinent to said community and surrounding geographic area.

45. The method of marketing and managing real property of claim 41, wherein:
said local information includes information about business and government entities and services pertinent to said community and surrounding geographic area.

46. A method for marketing and managing real property for property owners comprising:
entering into an agreement with said property owners to advertise an interest in properties available for sale or rent in a specific geographic region;
receiving a set of property related information from said property owners for each of said properties, said property related information including a location parameter, a price parameter, and an amenities listing;
entering said properties and said property related information in a database;
providing a processing unit with access to said database;
providing a display interface in communication with said processing unit;
establishing a relationship with a selected entity for providing relocation services to members of said entity;
compiling a set of common criteria for said members;
upon request from one of said members, displaying in a viewable format on a remote display device said property related information for said properties that satisfy said common criteria;
obtaining a set of member information about one of said members and a listing of selected properties satisfying said common criteria;
based on said set of member information, prescreening said one of said members prior to showing any of said selected properties;
upon approval of said one of said members, showing at least one of said selected properties to said one of said members;
upon an agreement being established between said one of said members and one of said property owners for purchasing or renting one of said selected properties, establishing a fee arrangement with one of said one of said members or said one of said property owners; and
collecting said fee.

47. The method of marketing and managing real property of claim 46, further comprising:
requiring said one of said members to correctly input specifically identified access information before displaying said property related information for said properties that satisfy said common criteria.

48. The method of marketing and managing real property of claim 46, wherein:
said entity is selected from a group consisting of governmental agencies, health care providers, medical groups, organizations, associations, partnerships, firms, leagues and corporations.
